(19) United States
(12) Patent Application Publication
(10) Pub. No.: US 2026/0307852 A1
(43) Pub. Date: Oct. 8, 2026

(54) CARTON WITH LOCKING FEATURES

(71) Applicant: Graphic Packaging International, LLC, Atlanta, GA (US)

(72) Inventors: Steven M. Oliveira, Canton, GA (US); Donald Spitler, Cumming, GA (US); Chuck Tarlton, Roswell, GA (US)

(21) Appl. No.: 19/714,723

(22) Filed: Jun. 22, 2026

Related U.S. Application Data
(63) Continuation-in-part of application No. 18/941,443, filed on Nov. 8, 2024.
(60) Provisional application No. 63/827,233, filed on Jun. 20, 2025.
(60) Provisional application No. 63/659,031, filed on Jun. 12, 2024.
(60) Provisional application No. 63/547,697, filed on Nov. 8, 2023.

(51) Int. Cl. B65D 5/66; B31B 50/26; B65D 5/44; B65D 5/46; B65D 5/54; B31B 100/00; B31B 120/10

(52) U.S. Cl. CPC B65D 5/6691; B31B 50/26; B65D 5/445; B65D 5/4604; B65D 5/54; B31B 2100/00; B31B 2120/102

(57) ABSTRACT

A carton for holding products. The carton can comprise a base part comprising a plurality of base panels extending at least partially around an interior of the carton and an at least partially open top end. A lid part can extend over at least a portion of the at least partially open top end of the base part in a closed configuration of the carton. The carton further can comprise locking features for cooperating to resist movement of the lid part relative to the base part from the closed configuration. The locking features can be operable to be disengaged for allowing pivoting of the lid part relative to the base part from the closed configuration to an open configuration of the carton.

### CROSS-REFERENCE TO RELATED APPLICATIONS

This application claims the benefit of U.S. Provisional Patent Application No. 63/827,233 filed Jun. 20, 2025. This application is a continuation-in-part application of U.S. Patent Application No. 18/941,443, which claims the benefit of U.S. Provisional Patent Application No. 63/547,697, which was filed on Nov. 8, 2023, and U.S. Provisional Patent Application No. 63/659,031, which was filed on Jun. 12, 2024.

### INCORPORATION BY REFERENCE

The disclosures of each of U.S. Provisional Patent Application No. 63/827,233 filed Jun. 20, 2025, U.S. Patent Application No. 18/941,443, filed Nov. 8, 2024, U.S. Provisional Patent Application No. 63/547,697, filed Nov. 8, 2023, and U.S. Provisional Patent Application No. 63/659,031, filed Jun. 12, 2024, are hereby incorporated by reference for all purposes as if presented herein in their entirety.

### BACKGROUND OF THE DISCLOSURE

The present disclosure generally relates to cartons for holding and dispensing products and to methods of forming the cartons. More specifically, the present disclosure is directed to cartons with reclosable lids and locking features for holding the cartons in a closed configuration.

Cartons with locking features can be used for a wide variety of different products, such as dishwashing and/or laundry agents, medicines, household cleaners, candles, cosmetics, tobacco, and other products that should be kept out of the hands of children, as they may put the products in their mouths, swallow them, or use them in other dangerous ways.

### SUMMARY OF THE DISCLOSURE

In general, one aspect of the disclosure is directed to a carton for holding products. The carton can comprise a base part comprising a plurality of base panels extending at least partially around an interior of the carton and an at least partially open top end. A lid part can extend over at least a portion of the at least partially open top end of the base part in a closed configuration of the carton. The carton further can comprise locking features for cooperating to resist movement of at least a pivot portion of the lid part relative to the base part from the closed configuration. The locking features can be operable to be disengaged for allowing pivoting of the pivot portion relative to the base part from the closed configuration to an open configuration of the carton.

In another aspect, the disclosure is generally directed to, in combination, a bottom blank and a top blank for cooperating to form a carton for holding one or more products. The bottom blank can comprise a plurality of base panels. The bottom blank can be for at least partially forming a base part having an at least partially open top end when the carton is formed from the bottom blank and the top blank. The top blank can be for forming a lid part extending over at least a portion of the at least partially open top end of the base part when the carton is formed from the bottom blank and the top blank in a closed configuration of the carton formed from the bottom blank and the top blank. The bottom blank and the top blank can comprise locking features and, when the carton is formed from the bottom blank and the top blank, the locking features can be for cooperating to resist pivoting of at least a pivot portion of the lid part relative to the base part in the closed configuration of the carton formed from the bottom blank and the top blank and can be for being operable to be disengaged for allowing pivoting of the pivot portion relative to the base part.

In another aspect, the disclosure is generally directed to a blank for forming a carton for holding one or more products. The blank can comprise a base portion comprising a plurality of base panels. The base portion can be for at least partially forming a base part having an at least partially open top end when the carton is formed from the blank. The blank further can comprise a lid portion for at least partially forming a lid part extending over at least a portion of the at least partially open top end of the base part when the carton is formed from the blank in a closed configuration of the carton formed from the blank. The blank also can comprise locking features for cooperating when the carton is formed from the blank to resist pivoting of at least a pivot portion of the lid part relative to the base part from the closed configuration of the carton formed from the blank. The locking features can be operable to be disengaged for allowing pivoting of the pivot portion relative to the base part when the carton is formed from the blank.

In another aspect, the disclosure is generally directed to a method of forming a carton. The method can comprise obtaining a bottom blank and a top blank. The bottom blank can comprise a plurality of base panels, and the bottom blank and the top blank can comprise locking features. The method further can comprise forming a base part of the carton by positioning the plurality of base panels to extend at least partially around an interior of the base part. The base part can comprise an at least partially open top end. The method also can comprise forming a lid part of the carton from at least the top blank and positioning the lid part to extend over at least a portion of the at least partially open top end of the base part in a closed configuration of the carton. The locking features can be for cooperating to resist pivoting of at least a pivot portion of the lid part relative to the base part from the closed configuration, and the locking features can be operable to be disengaged for allowing pivoting of the pivot portion relative to the base part from the closed configuration to an open configuration of the carton.

In another aspect, the disclosure is generally directed to a method of forming a carton. The method can comprise obtaining a blank comprising a base portion, a lid portion, and locking features extending in the base portion and the lid portion. The base portion can comprise a plurality of base panels. The method further can comprise forming a base part of the carton by positioning the plurality of base panels to extend at least partially around an interior of the base part. The base part can comprise an at least partially open top end. The method also can comprise forming a lid part of the carton from at least the lid portion of the blank and positioning the lid part to extend over at least a portion of the at least partially open top end of the base part in a closed configuration of the carton. The locking features can be for cooperating to resist pivoting of at least a pivot portion of the lid part relative to the base part from the closed configuration, and the locking features can be operable to be disengaged for allowing pivoting of the pivot portion relative to the base part from the closed configuration to an open configuration of the carton.

In another aspect, the disclosure is generally directed to a carton for holding one or more products, the carton comprises a base part, the base part comprising a plurality of base panels extending at least partially around an interior of the carton and an at least partially open top end, a lid part extending over at least a portion of the at least partially open top end of the base part in a closed configuration of the carton, and locking features for cooperating to resist movement of the lid part relative to the base part from the closed configuration. The locking features are operable to be disengaged for allowing pivoting of lid part relative to the base part from the closed configuration to an open configuration of the carton. The base part comprises a bottom locking flap, and the lid part comprises a lid locking panel foldably connected to a lid top panel, wherein the locking features comprise the bottom locking flap and the lid locking panel, and the bottom locking flap and the lid locking panel engage one another in a locking configuration to resist pivoting of the lid part relative to the base part in the closed configuration. The bottom locking flap comprises a proximal portion foldably connected to a base panel of the plurality of base panels and a distal portion foldably connected to the proximal portion at a fold line, the proximal portion and the distal portion being in at least partial face-to-face contact, and at least one locking tab extends from the distal portion.

In another aspect, the disclosure is generally directed to a blank for forming a carton for holding one or more products. The blank comprising a base portion, the base portion comprising a plurality of base panels, wherein the base portion is for at least partially forming a base part having an at least partially open top end when the carton is formed from the blank, a lid portion for at least partially forming a lid part extending over at least a portion of the at least partially open top end of the base part when the carton is formed from the blank in a closed configuration of the carton formed from the blank, and locking features for cooperating when the carton is formed from the blank to resist pivoting of the lid part relative to the base part from the closed configuration of the carton formed from the blank, the locking features being operable to be disengaged for allowing pivoting of the lid part relative to the base part when the carton is formed from the blank. The base part comprises a bottom locking flap, and the lid portion comprises a lid locking panel foldably connected to a lid top panel, wherein the locking features comprise the bottom locking flap and the lid locking panel, and the bottom locking flap and the lid locking panel are for engaging one another in a locking configuration to resist pivoting of the lid part relative to the base part in the closed configuration of the carton formed from the blank. The bottom locking flap comprises a proximal portion foldably connected to a base panel of the plurality of base panels and a distal portion foldably connected to the proximal portion at a fold line, the proximal portion and the distal portion for being in at least partial face-to-face contact, and at least one locking tab extends from the distal portion in the carton formed from the blank.

In another aspect, the disclosure is generally directed to a method of forming a carton. The method comprising obtaining a blank, the blank comprising a base portion, a lid portion, and locking features extending in the base portion and the lid portion, the base portion comprising a plurality of base panels. The method comprises forming a base part of the carton by positioning the plurality of base panels to extend at least partially around an interior of the base part, wherein the base part comprises an at least partially open top end, forming a lid part of the carton from at least the lid portion of the blank, and positioning the lid part to extend over at least a portion of the at least partially open top end of the base part in a closed configuration of the carton. The locking features are for cooperating to resist pivoting of the lid part relative to the base part from the closed configuration, and the locking features are operable to be disengaged for allowing pivoting of the lid part relative to the base part from the closed configuration to an open configuration of the carton. The base portion comprises a bottom locking flap, and the lid portion comprises a lid locking panel foldably connected to a lid top panel, the locking features comprise the bottom locking flap and the lid locking panel, and the bottom locking flap and the lid locking panel engage one another in a locking configuration to resist pivoting of the lid part relative to the base part in the closed configuration. The bottom locking flap comprises a proximal portion foldably connected to a base panel of the plurality of base panels and a distal portion foldably connected to the proximal portion at a fold line, the forming the base part comprises positioning the proximal portion and the distal portion in an at least partial face-to-face contact and forming at least one locking tab extending from the distal portion.

Additional aspects, features, and advantages of the present invention will become apparent from the following description and accompanying figures.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIGS. 1 and 2 are plan views of a respective bottom blank and top blank used for at least partially forming a respective base part and lid part of a container according to exemplary embodiments of the disclosure.

FIG. 3 is an isometric view of a base part formed from the bottom blank of FIG. 1 according to exemplary embodiments of the disclosure.

FIGS. 4 and 5 are front and back isometric views, respectively, of a carton formed from the base part of FIG. 3 and a lid part formed from the top blank of FIG. 2 according to exemplary embodiments of the disclosure.

FIG. 6 is an isometric end view of the carton of FIGS. 4 and 5 with an actuated initial opening feature according to exemplary embodiments of the disclosure.

FIG. 7 is an isometric view showing the opening of the carton of FIGS. 4-6 according to exemplary embodiments of the disclosure.

FIG. 8 is an isometric view showing the carton of FIGS. 4-7 with the lid in an open configuration according to exemplary embodiments of the disclosure.

FIG. 9 is a plan view of a top blank for cooperating with the bottom blank of FIG. 1 for forming a container according to further exemplary embodiments of the disclosure.

FIG. 10 is an isometric view of a carton formed from a lid part formed from the top blank of FIG. 20 and the base part of FIG. 3 according to further exemplary embodiments of the disclosure.

FIG. 11 is an isometric view showing the opening of the carton of FIG. 10 according to further exemplary embodiments of the disclosure.

FIG. 12 is an isometric view showing the carton of FIGS. 10 and 11 with the lid in an open configuration according to further exemplary embodiments of the disclosure.

FIG. 13 is a plan view of a carton blank for forming a carton according to further exemplary embodiments of the disclosure.

FIG. 14 is an isometric view of a carton formed from the carton blank of FIG. 13 according to further exemplary embodiments of the disclosure.

FIGS. 15A-15C are isometric views showing the opening of the carton of FIG. 15 according to further exemplary embodiments of the disclosure.

FIG. 16 is an isometric view of the carton of FIGS. 14-15C in an open configuration according to further exemplary embodiments of the disclosure.

FIGS. 17A and 17B are isometric views showing the reclosing of the carton of FIG. 16 according to further exemplary embodiments of the disclosure.

FIG. 18 is a plan view of a carton blank for forming a carton according to further exemplary embodiments of the disclosure.

FIG. 19 is an isometric view of a carton formed from the carton blank of FIG. 18 according to further exemplary embodiments of the disclosure.

FIG. 20 is an isometric view of the carton of FIG. 19 in an open configuration according to further exemplary embodiments of the disclosure.

FIGS. 21 and 22 are plan views of a respective bottom blank and top blank used for at least partially forming a respective base part and lid part of a carton according to further exemplary embodiments of the disclosure.

FIGS. 23 and 24 are front and back isometric views, respectively, of a carton formed from the bottom blank of FIG. 21 and the top blank of FIG. 22 according to further exemplary embodiments of the disclosure.

FIG. 25 is an isometric view of the carton of FIGS. 23 and 24 in an open configuration according to further exemplary embodiments of the disclosure.

FIG. 26 is a plan view of a carton blank for forming a carton according to further exemplary embodiments of the disclosure.

FIG. 27 is an isometric view of a carton formed from the carton blank of FIG. 26 according to further exemplary embodiments of the disclosure.

FIG. 28 is an isometric view of the carton of FIG. 27 in an open configuration according to further exemplary embodiments of the disclosure.

FIG. 29 is a schematic front view of the carton of FIG. 27 showing locking features.

FIG. 30 is an isometric view of the carton of FIG. 27.

FIG. 31 is a plan view of a carton blank for forming a carton according to further exemplary embodiments of the disclosure.

FIG. 32 is an isometric view of a carton formed from the carton blank of FIG. 31 according to further exemplary embodiments of the disclosure.

FIG. 33 is an isometric view of the carton of FIG. 32 in an open configuration according to further exemplary embodiments of the disclosure.

Corresponding parts are designated by corresponding reference numbers throughout the drawings.

### DETAILED DESCRIPTION OF THE EXEMPLARY EMBODIMENTS

The present disclosure generally relates to constructs, boxes, cartons, carriers, trays, or the like, and packages for holding one or more products or articles such as those that should be kept out of the hands of children (e.g., for safety reasons). The product or products can be cleaning products such as laundry pods, dishwashing agents, household cleaners, soaps, and the like; cat litter and/or other suitable granular and/or flowable materials; medicines; cosmetics; candles; tobacco; food items; objects that may pose a choking hazard; any other suitable product or material; or combinations thereof.

Cartons according to the present disclosure can accommodate product or articles of any shape. In this specification, the terms “inner,” “interior,” “outer,” “exterior,” “lower,” “bottom,” “upper,” and “top” indicate orientations determined in relation to fully erected and upright cartons. As described herein, cartons can be formed from blanks with multiple panels, portions, tabs, flaps, fold lines and/or other lines of weakening, and/or other aspects that may be designated herein in terms relative to one another, e.g., “first,” “second,” “third,” etc., in sequential or nonsequential reference, without departing from the disclosure.

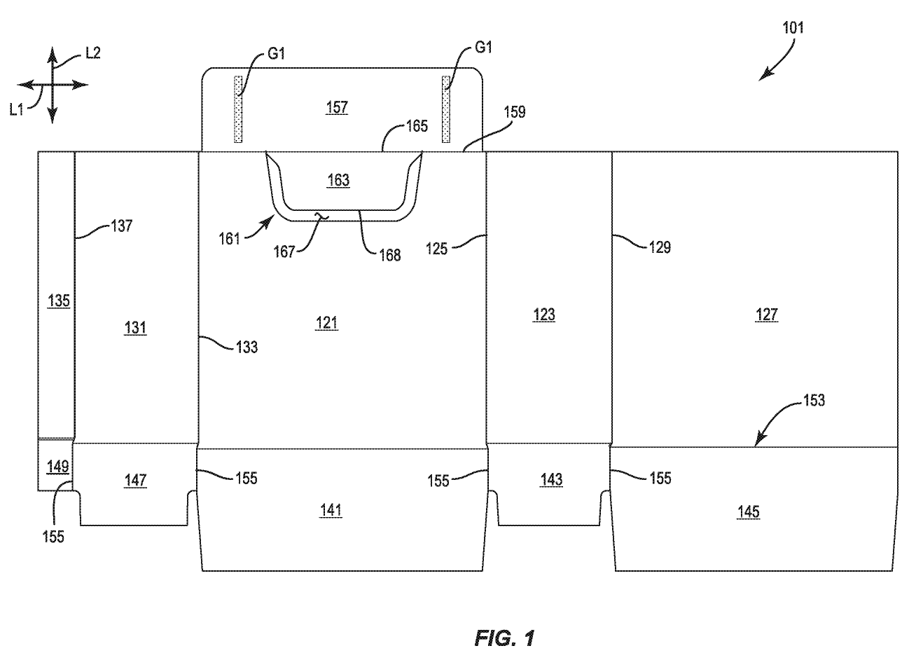

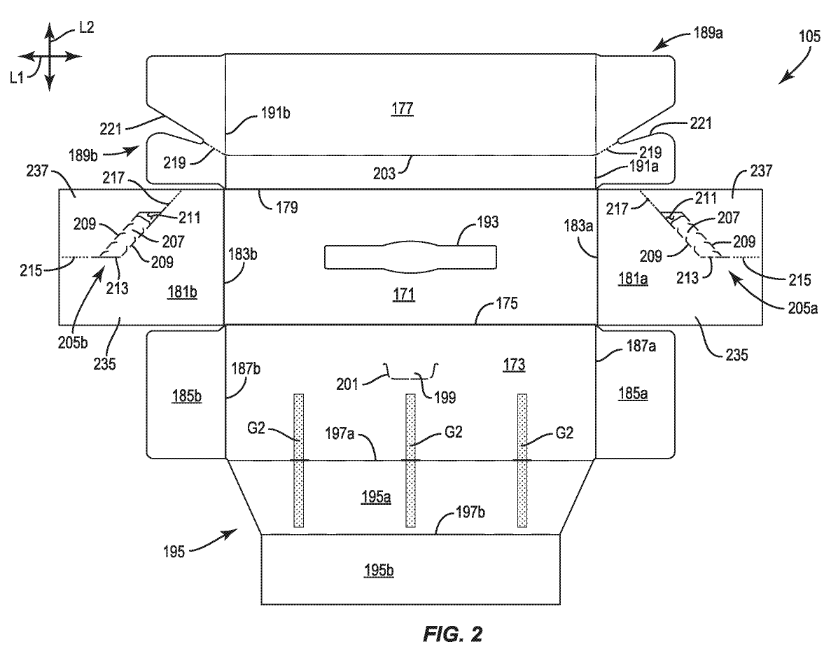

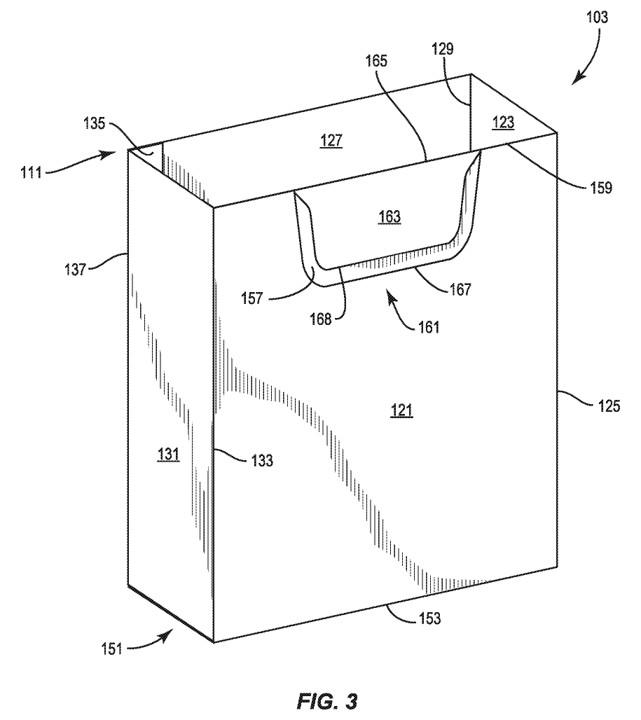

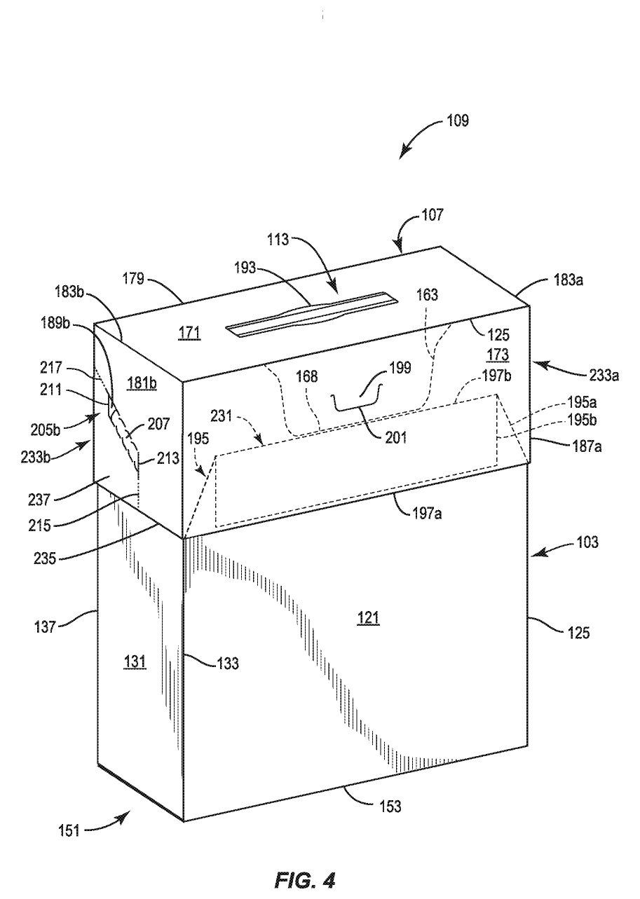

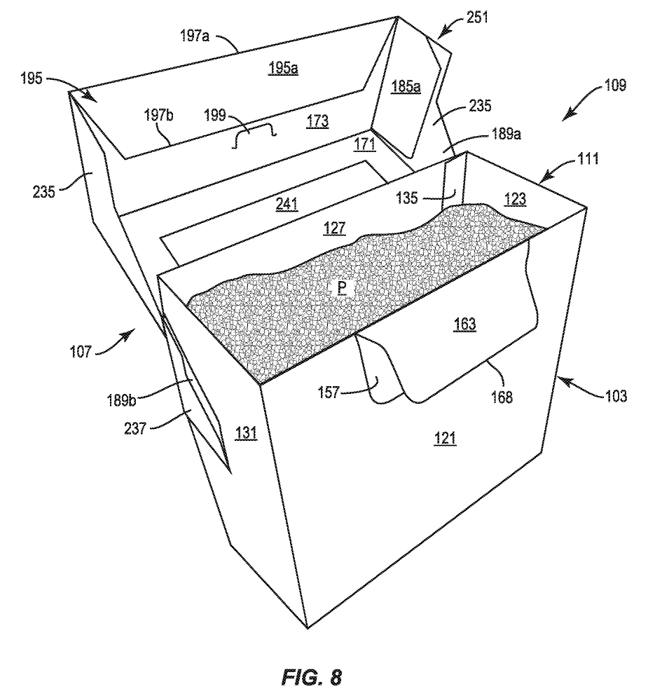

FIG. 1 illustrates an exterior surface of a first or bottom blank 101 for forming a first or base part 103 (e.g., a first or base construct) (FIG. 3), which can at least partially form a container used to hold one or more products P (e.g., FIG. 8). FIG. 2 illustrates an exterior surface of a second or top blank 105 used to form a second or lid part 107 (e.g., a second or lid construct) (FIG. 4). In embodiments, the base or container part 103 and the top or lid part 107 can cooperate to form a carton 109 (FIGS. 4-8) with the lid part 107 at least partially closing an open top end 111 of the base part 103. In the illustrated embodiments, the carton 109 can include opening features for facilitating an initial opening of the package, as described in more detail below. Further, in embodiments, the base part 103 and the lid part 107 can include locking and/or stop features for cooperating to resist and/or limit movement of the lid part 107 relative to the base part 103, as described in more detail below. In the illustrated embodiments, resisting movement can include partially or fully preventing movement. In some embodiments, the carton 109 can include a handle 113, as described in more detail below. In exemplary embodiments, the blanks 101, 105 can be made of paperboard, cardboard, corrugated cardboard, and/or other suitable material(s). For example, either or both of the blanks 101, 105 can include a heavyweight and/or thick paperboard, multi-ply paperboard (e.g., Z-flute material available from Graphic Packaging International, LLC, of Atlanta, GA), micro-flute material, corrugated material, and/or combinations thereof. In the illustrated embodiments, the bottom blank 101 can be a corrugated material and the top blank 105 can be a laminated material (e.g., including paperboard). The blanks 101, 105 could be made of any suitable materials and/or combinations of materials without departing from the disclosure.

As shown in FIG. 1, the bottom blank 101 has a longitudinal axis L1 and a lateral axis L2. In the illustrated embodiments, the bottom blank 101 comprises a front panel 121 (e.g., a base front panel) foldably connected to a first side panel 123 (e.g., a base first side panel) at a first lateral fold line 125. A back panel 127 (e.g., a base back panel) is foldably connected to the first side panel 123 at a second lateral fold line 129. A second side panel 131 (e.g., a base second side panel) is foldably connected to the front panel 121 at a third lateral fold line 133. In the illustrated embodiments, the bottom blank 101 includes an attachment panel 135 foldably connected to the second side panel 131 at a fourth lateral fold line 137. Any of the panels 121, 123, 127, 131, 135 could be omitted or could be otherwise shaped, arranged, configured, and/or positioned without departing from the disclosure. For example, the attachment panel 135 could be foldably connected to the back panel 127 or could be omitted without departing from the disclosure.

The front panel 121 is foldably connected to a front bottom flap 141, the first side panel 123 is foldably connected to a first side bottom flap 143, the back panel 127 is foldably connected to a back bottom flap 145, the second side panel 131 is foldably connected to a second side bottom flap 147, and the attachment flap 135 is foldably connected to a bottom flap 149. When the base part 103 is erected, the front and back bottom flaps 141, 145, side bottom flaps 143, 147, and the bottom flap 149 (e.g., the bottom flaps 141, 143, 145, 147, 149) can close a bottom end 151 of the base part 103 (FIGS. 3 and 4). In accordance with an alternative embodiment of the present disclosure, different flap arrangements can be used for at least partially closing the bottom end 151 and/or the top end of the base part 103.

The front and back bottom flaps 141, 145, side bottom flaps 143, 147, and the bottom flap 149 extend along a marginal area of the bottom blank 101 and are foldably connected at a longitudinal fold line 153 that extends along the length of the blank. The longitudinal fold line 153 may be, for example, substantially straight, or offset at one or more locations to account for blank thickness and/or for other factors. In exemplary embodiments, the bottom flaps 141, 143, 145, 147, 149 can be separable from respectively adjacent bottom flaps along respective cut lines 155 or other suitable lines of weakening. As shown in FIG. 1, the first side bottom flap 143 is further separable from the front and back panels 121, 127 along the respective cuts 155, the second side bottom flap 147 is further separable from the front panel 121 along the cut 155, and the bottom flap 149 is further separable from the second side panel 131 along the cut 155. Alternatively, the bottom flaps could be spaced apart from one another in the bottom blank 101. Any of the bottom flaps 141, 143, 145, 147, 149 could be omitted or could be otherwise shaped, arranged, configured, and/or positioned without departing from the disclosure.

As shown in FIG. 1, the bottom blank 101 can include a closure panel or closure flap 157 foldably connected to the front panel 121 along a longitudinal fold line 159 and a bottom or base locking feature 161 for cooperating with locking features in the top part 107 when the carton 109 is formed (FIG. 4). In embodiments, the bottom locking feature 161 can include a bottom locking flap 163 foldably connected to the closure flap 157 along a longitudinal fold line 165, which can be collinear with the longitudinal fold line 159. As shown in FIG. 1, the bottom locking flap 163 can be spaced from the front panel 121 by a cutout 167 in the front panel 121 so that the bottom locking flap 163 extends along an opening in the front panel 121 with a distal edge 168 of the bottom locking flap 163 extending along the cutout 167. In embodiments, the bottom locking flap 163 can be otherwise separable from the front panel 121 (e.g., along a cut or tear line or other suitable line of weakening). In the illustrated embodiments, the closure flap 157 can be sized so that it is larger than the bottom locking flap 163 and the cutout 167 in the front panel 121 so that the closure flap 157 covers (e.g., closes) the opening in the front panel 121 when the closure flap 157 is folded into face-to-face contact with the front panel 121 (e.g., FIG. 3). The closure flap 157 and/or the base locking feature 161 could be omitted or could be otherwise shaped, arranged, configured, and/or positioned without departing from the disclosure.

The bottom blank 101 could be otherwise shaped, arranged, and/or configured without departing from the disclosure.

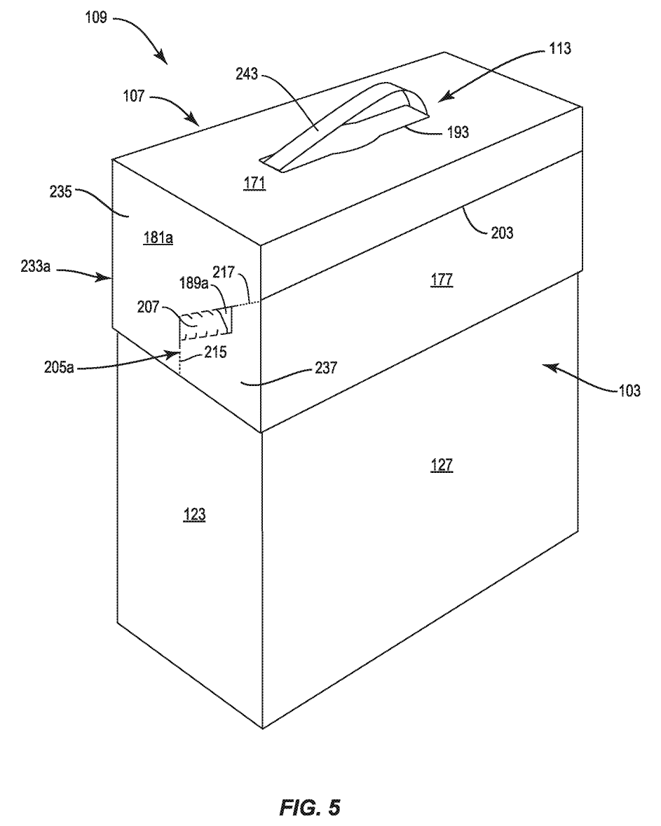

As shown in FIG. 2, the second or top blank 105 for the top or lid part/construct 107 can have a longitudinal direction L1 and a lateral direction L2. In the illustrated embodiment, the top blank 105 can include a top or central panel 171 that is foldably connected to a lid front panel 173 along a first longitudinal fold line 175 and to a lid back panel 177 along a second longitudinal fold line 179. As shown in FIG. 2, the top panel 171 can be foldably connected to two opposing end panels 181a, 181b along respective lateral fold lines 183a, 183b, the lid front panel 173 can be foldably connected to two opposing lid front end flaps 185a, 185b along respective lateral fold lines 187a, 187b, and the lid back panel 177 can be foldably connected to two opposing lid back end flaps 189a, 189b along respective lateral fold lines 191a, 191b. In the illustrated embodiments, a handle opening 193 can extend in the top panel 171 (e.g., in the center of the top panel 171), such as for forming the handle 113 (e.g., a Wilton handle, such as shown in FIGS. 5-7 and 9-15, or another suitable handle). Any of the top panel 171, the lid front panel 173, the lid back panel 177, the end panels 181a, 181b, and/or the end flaps 185a, 185b, 189a, 189b could be omitted or could be otherwise shaped, arranged, configured, and/or positioned without departing from the disclosure.

In the illustrated embodiments, the lid front panel 173 can be foldably connected to a lid locking feature, which can include a lid locking panel 195 foldably connected to the lid front panel 173 along a longitudinal fold line 197a. As shown in FIG. 2, the lid locking panel 195 can include a proximal portion 195a that is foldably connected to the lid front panel 173 along the fold line 197a and a distal portion 195b that is foldably connected to the proximal portion 195a along a longitudinal fold line 197b. As described in more detail below, the portions 195a, 195b of the lid locking panel 195 can be folded along the longitudinal fold lines 197a, 197b into the interior of the lid 107 so that the longitudinal fold line 197b forms a lid locking edge. In embodiments, the distal portion 195b can be smaller (e.g., in the lateral direction L2 and the longitudinal direction L1) so that the proximal portion 195a has oblique free edges extending between respective ends of the longitudinal fold lines 197a, 197b and so that the distal portion 195b can be folded into face-to-face contact with the proximal portion 195a without overlapping the longitudinal fold line 197a. The lid locking feature could be omitted or could be otherwise shaped, arranged, configured, and/or positioned without departing from the disclosure.

As shown in FIG. 2, a tab 199 (e.g., an opening or actuating tab or unlocking tab) can extend in the lid front panel 173. In embodiments, the tab 199 can be separable from the lid front panel along a cut or tear line 201 or other suitable line of weakening. For example, the tear line 201 could be a generally U-shaped cut line with a plurality of nicks that hold the tab 199 in the plane of the lid front panel 173 until the nicks are broken when the tab 199 is first used to unlock the lid 107 (as discussed in more detail below). In the illustrated embodiments, the tear line 201 can have a curved tear stop at each of its ends. As shown in FIG. 2, a fold line or hinge line 203 can extend in the longitudinal direction in the lid back panel 177 (e.g., across the lid back panel 177 from the lateral fold line 191a to the lateral fold line 191b). In embodiments, the hinge line 203 can form a hinge for pivoting the lid 107 between a closed configuration and an open configuration. The tab 199, the tear line 201, and/or the hinge line 203 could be omitted or could be otherwise shaped, arranged, configured, and/or positioned without departing from the disclosure.

In the illustrated embodiments, the top blank 105 can include initial opening features for holding the carton 109 in its closed configuration (e.g., in addition to the locking features), such as during storage and/or prior to sale of the carton 109 and its contents. In embodiments, once the initial opening features are actuated/opened (e.g., when the carton 109 is first opened by a user), the actuated initial opening features can provide evidence that the carton has been opened (e.g., tamper evident features). As shown in FIG. 2, the initial opening features can include a first opening feature 205a in the first end panel 181a and the first lid back flap 189a and a second opening feature 205b in the second end panel 181b and the second lid back flap 189b. Each of the opening features 205a, 205b can include a tear strip 207 at least partially defined by two spaced, oblique tear lines 209 extending in the respective end panels 181a, 181b. An access opening 211 can extend in the respective end panels 181a, 181b at a first end (e.g., initiation end) of the respective tear strips 207, and the tear strips 207 can terminate at a cut line 213 (e.g., a longitudinal cut line) in the respective end panels 181a, 181b. In some embodiments, the tear strips 207 can remain connected to the respective end panels 181a, 181b by nicks (e.g., one or more nicks) interrupting the cut line 213 until the tear strip 207 is torn away during actuation. As shown in FIG. 2, a tear line 215 (e.g., a longitudinal tear line) can extend from the cut line 213 to a distal free edge of the respective end panel 181a, 181b and a tear line 217 can extend from the access opening 211 to another free edge of the respective end panel 181a, 181b (e.g., a free edge extending proximate to the respective lid back flaps 189a, 189b).

As shown in FIG. 2, the opening features 205a, 205b further can include a tear line 219 or other suitable line of weakening extending in the respective lid back end flaps 189a, 189b. In embodiments, the tear lines 219 can extend from respective ends of the hinge line 203 to a free edge of the respective lid back end flaps 189a, 189b. In exemplary embodiments, the tear lines 219 can at least partially define two portions (e.g., an upper portion and a lower portion) of the respective lid back end flaps 189a, 189b. In the illustrated embodiments, a cutout 221 can extend in the lid back end flaps 189a, 189b between the upper and lower portions and the oblique tear lines 219 can extend from the respective ends of the hinge line 203 to the respective cutouts 221 so that the tear lines 219 and the cutouts 221 cooperate to at least partially define the upper and lower portions of the lid back end flaps 189a, 189b. Any of the initial opening features could be omitted or could be otherwise shaped, arranged, configured, and/or positioned without departing from the disclosure.

The top blank 105 could be otherwise shaped, arranged, and/or configured without departing from the disclosure.

In the illustrated embodiments, the closure flap 157 can be folded along the longitudinal fold line 159 into overlapping relationship with the front panel 121, such as so an interior surface of the closure flap 157 is in face-to-face contact with an interior surface of the front panel 121 and the bottom locking flap 163. In embodiments, the closure flap 157 can be glued or otherwise secured in face-to-face contact with the interior surface of the front panel 121 (e.g., by glue strips G1 shown in FIG. 1). In the illustrated embodiments, the closure flap 157 and the bottom locking flap 163 can remain unattached to one another so that the bottom locking flap 163 is free to fold away from the closure flap 157 out of the plane of the front panel 121 (e.g., FIG. 8). In exemplary embodiments, the longitudinal fold line 165 connecting the bottom locking flap 163 to the closure flap 157 can be configured so that the bottom locking flap 163 is biased outwardly (e.g., tends to fold away from the closure flap 157 out of the plane of the front panel 121) so that the bottom locking flap 163 tends to engage the lid locking panel 195 in the closed carton 109 (FIGS. 4-7).

As shown in FIG. 3, the base part 103 can be formed from the bottom blank 101 by folding the bottom blank 101 along the lateral fold lines 125, 129, 133, 137 so that the attachment panel 135 and the back panel 127 are overlapped. In embodiments, an exterior surface of the attachment panel 135 can be attached (e.g., glued) in face-to-face contact with an interior surface of the back panel 127. In exemplary embodiments, the folded blank with the attachment panel 135 attached to the back panel 127 can be in the form of a flattened sleeve (not shown). The panels 121, 123, 127, 131, 135 can be folded with respect to one another to be arranged in an open-ended sleeve (not shown) with the front panel 121 opposite to the back panel 127 and the attachment panel 135 and with the first side panel 123 opposite to the second side panel 131. In embodiments, the bottom flaps 141, 143, 145, 147, 149 can be overlapped and glued to at least partially close the bottom 151 of the base part 103. The top 111 of the base part 103 can remain at least partially open. The base part 103 could be otherwise formed without departing from the disclosure. For example, the closure flap 157 could be folded before or after forming the open-ended sleeve.

As schematically shown with hidden lines in FIG. 4, the distal portion 195b of the lid locking panel 195 can be folded along the longitudinal fold line 197b into an overlapping relationship with the proximal portion 195a, which can be folded along the longitudinal fold line 197a so that the portions 195a, 195b of the lid locking panel 195 are in an overlapping relationship with the lid front panel 173. In embodiments, an interior surface of the distal portion 195b can be in face-to-face contact with an interior surface of the proximal portion 195a and an exterior surface of the distal portion 195b can be in face-to-face contact with an interior surface of the front panel 173 so that the distal portion 195b is positioned between the lid front panel 173 and the proximal portion 195a. In exemplary embodiments, the distal portion 195b can be attached (e.g., glued) in face-to-face contact with each of the proximal portion 195a and the lid front panel 173, such as by glue strips G2 (e.g., lateral glue strips as shown in FIG. 2). In the illustrated embodiments, the spacing between the fold lines 197a, 197b can be less than the distance between the fold line 197a and the cut line 201 defining the tab 199 so that the lid locking panel 195 does not overlap the tab 199 (FIG. 4). As shown in FIG. 4, the spacing between the fold lines 197a, 197b can cause the fold line 197b to be positioned proximate to the tab 199. In the illustrated embodiments, the longitudinal fold line 197b can at least partially form a lid engagement edge 231 (e.g., having the thickness of the overlapped portions 195a, 195b of the lid locking panel 195).

As shown in FIG. 4, the lid part 107 can be formed by folding the lid front panel 173 and the lid back panel 177 downwardly along the longitudinal fold lines 175, 179 relative to the top panel 171, folding the end flaps 185a, 189a over a first end 233a of the lid part 107, and folding the end flaps 185b, 189b over a second end 233b of the lid part 107. In the illustrated embodiments, the end panels 181a, 181b can be folded downwardly along the respective lateral fold lines 183a, 183b relative to the top panel 171 so that the end panels 181a, 181b at least partially overlap the respective end flaps 185a, 189a and 185b, 189b. In embodiments, the overlapped end panels 181a and end flaps 185a, 189a can at least partially close the first end 233a of the lid part 107 and the overlapped end panels 181b and end flaps 185b, 189b can at least partially close the second end 233b of the lid part 107. In the illustrated embodiments, the end flap 185a and the upper portion of the end flap 189a can be glued in face-to-face contact with an interior surface of a first or main portion 235 of the end panel 181a and the lower portion of the end flap 189a can be glued in face-to-face contact with an interior surface of a second or removable portion 237 of the end panel 181a. Further, the end flap 185b and the upper portion of the end flap 189b can be glued in face-to-face contact with an interior surface of the main portion 235 of the end panel 181b and the lower portion of the end flap 189b can be glued in face-to-face contact with an interior surface of the removable portion 237 of the end panel 181b. In exemplary embodiments, the removable portions 237 of the end panels 181a, 181b can be spaced from the top panel 171 and can be at least partially defined by the respective tear strips 207 and tear lines 215, 217. The lid part 107 is shown in FIGS. 4 and 5. The lid part 107 could be otherwise formed without departing from the disclosure. For example, the lid locking panel 195 could be folded before or after forming the lid part 107.

In embodiments, the top blank 105, the partially formed lid part, or the formed lid part 107 could be attached to the bottom blank 101, the partially formed base part, or the formed base part 103 prior to, during, or after formation of the lid part 107 and/or the base part 103 from the respective top blank 105 and bottom blank 101. In the illustrated embodiments, at least a portion of the back panel 177 extending from the hinge line 203 to a free distal edge of the back panel 177 can be attached (e.g., glued) to the base back panel 127 and the lower portions of the lid back end flaps 189a, 189b can be attached (e.g., glued) to the respective first side panel 123 and second side panel 131. For example, the removable portions 237 of the end panels 181a, 181b can be secured to the side panels 123, 131 via the lower portions of the lid back end flaps 189a, 189b. As shown in FIG. 5, the open top end 111 of the base part 103 can be received in an interior of the lid part 107 through an open bottom of the lid part 107 when the lid back panel 177 and the lid back end flaps 189a, 189b are attached in face-to-face contact with the base back panel 127 and the base side panels 123, 131 and the base part 103 and the lid part 107 are formed.

As shown in FIGS. 4 and 5, the attached lid part 107 and base part 103 form the carton 109. In the illustrated embodiments, the intact tear strips 207 and tear lines 215, 217, 219 of the opening features 205a, 205b can help retain the lid part 107 in its closed position extending over the open top end 111 of the base part 103. Further, as schematically shown in FIG. 4, the bottom locking flap 163 can cooperate with the lid engagement edge 231 of the lid locking panel 195 to further retain the lid part 107 in its closed configuration. For example, forces that would tend to lift or pivot the lid part 107 upwardly with respect to the base part 103 would be resisted by the opening features 205a, 205b and/or the engagement of the bottom locking flap 163 and the lid engagement edge 231. The carton 109 could be otherwise formed without departing from the disclosure.

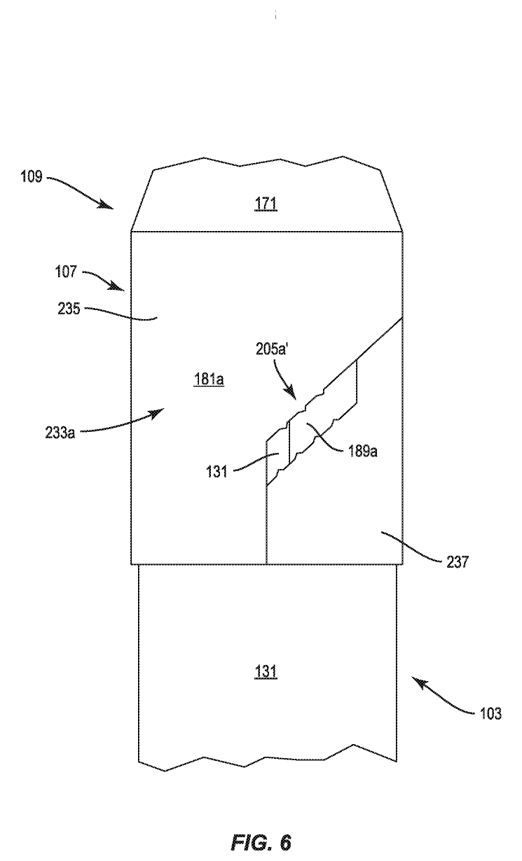

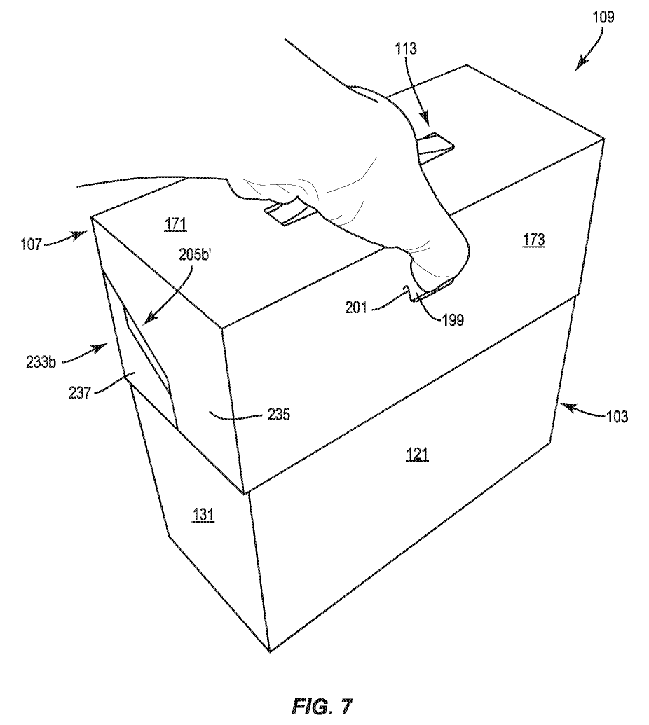

In the illustrated embodiments, the carton 109 can be opened (e.g., for the first time) by actuating the opening features 205a, 205b and then manipulating the tab 199 and the bottom locking flap 163. In embodiments, the tear strip 207 can be removed (e.g., by grasping the end of the tear strip 207 extending along the access opening 211 and tearing the tear strip 207 along the tear lines 209 and the cut line 213). In embodiments, the actuated opening features 205a', 205b' are shown in FIGS. 6 and 7, wherein the tear strip 207 has been removed and the end panels 181a, 181b have been torn along the tear lines 215, 217, 219. As shown in FIG. 7, a user can press inwardly on the tab 199, which can press the tab 199 against the bottom locking flap 163 to press the bottom locking flap 163 inwardly into the opening 167 in the bottom front panel 121 and out of the path of the lid locking panel 195. While pressing inwardly on the tab 199, the user can pivot the lid front panel 173 and the lid top panel 171 upwardly, which can cause the ends 233a, 233b of the lid part 207 to tear along the tear lines 215, 217, 219 so that the main portions 235 of the end panels 181a, 181b and the upper portions of the lid back end flaps 189a, 189b are separated from the removeable portions 237 of the end panels 181a, 181b and the lower portions of the lid back end flaps 189a, 189b. Alternatively, the tear lines 215, 217, 219 can be torn by pulling outwardly on the main portions 235 of the end panels 181a, 181b, for example. Accordingly, the portions of the lid part 107 that are not glued to the base part 103 are separated from the portions of the lid part 107 that are glued to the base part 103 except along the hinge line 203, and, as long as the locking flap 163 and the locking panel 195 are disengaged, the lid can pivot upwardly along the hinge line 203 (FIG. 8). In embodiments, the top panel 171, the lid front panel 173, the lid front end flaps 185a, 185b, the main portions 235 of the end panels 181a, 181b, the upper portions of the lid back end flaps 189a, 189b, and the upper portion of the lid back panel 177 extending above the hinge line 203 can at least partially form a reclosable lid or pivot portion 251 of the carton 109. As shown in FIG. 8, when the lid 251 is opened, the open top end 111 of the base part 103 is accessible for removing one or more items (e.g., product P23w44-) from the interior of the carton 109 and/or for loading one or more items into the carton 109.

In embodiments, the lid 251 can be closed by pivoting the lid downwardly along the hinge line 203 so that the main portions 235 of the end panels 181a, 181b overlap the respective base side panels 123, 131 and the lid front panel 173 overlaps the base front panel 121 and so that the top panel 171 covers the open top end 111 of the base part 103. In the illustrated embodiments, the lid locking panel 195 can move past the bottom locking flap 163 so that the lid engagement edge 231 extends under the bottom locking flap 163 and the locking features of the carton 109 are returned to the locked configuration. Accordingly, the lid locking panel 195 and the bottom locking flap 163 can cooperate to retain the carton 109 in its closed configuration (FIGS. 4-6). In exemplary embodiments, the carton 109 can provide an audio cue (e.g., a click, snap, etc.) when the lid is fully closed and the bottom locking flap 163 moves into position aligned for engagement with the lid engagement edge 231 (e.g., due to the outward bias of the locking flap 163). In embodiments, the lid can be reopened by pressing the tab 199 inwardly to disengage the bottom locking flap 163 from the lid locking panel 195 and pivoting the lid upwardly as described above and reclosed by pivoting the lid downwardly as described above multiple times for accessing the contents of the carton 109 and/or for placing items into the interior of the carton 109. The carton 109 can be otherwise opened, closed, reopened, and/or reclosed without departing from the disclosure.

In embodiments, the locking components of the carton 109 can be strategically formed and located within the structure of the carton 109 for facilitating the retention of products in the interior of the carton 109, for facilitating ease of transport of the carton 109 (e.g., when the carton has been reclosed after initial opening), and for helping secure the product against accidental access. For example, the bottom locking flap 163 and the lid locking panel 195 can be sized and located so that the distal edge 168 of the bottom locking flap 163 and the lid engagement edge 231 of the lid locking panel 195 can be aligned for engagement and/or in contact with one another when the carton 109 is in its closed configuration. Further, in embodiments, the bottom locking flap 163 can be configured to be biased outwardly, such as so it tends to bend outwardly away from the plane of the base front panel 121 (FIG. 8) and toward the lid front panel 173. The outward bias of the bottom locking flap 163 and the thickness of the lid locking panel 195 at the lid engagement edge 231 (e.g., due to the overlapping of the portions 195a, 195b of the lid locking panel 195 along the fold line 197b) can help the locking components to be in locking engagement (e.g., the bottom locking flap 163 blocking upward movement of the lid locking panel 195) when the carton 109 is in its closed configuration. In exemplary embodiments, the locking engagement of the lid and the base part 103 can resist accidental opening and/or resist opening of the carton 109 by a child. For example, a child that is too young to have access to the contents of the carton 109 may not have the knowledge and/or the dexterity to open the carton 109 when it is fully closed (e.g., a child may not know to press the tab 199 to release the locking features while lifting upwardly on the lid and/or a child may not have the dexterity to do so).

In embodiments, the carton 109 can provide an audio cue to a user when the lid is moved to its fully closed configuration (e.g., due to the locking flap 163 snapping against the lid front panel 173 over the lid locking panel 195 as the lid locking panel 195 moves below the bottom locking flap 163 during closing) to alert the user that the locking features are engaged and the carton 109 is in a child resistant configuration to help prevent a child from accessing the contents of the carton 109. In the illustrated embodiments, the opening features 205a, 205b can provide tamper evidence in the event that the carton 109 was opened and/or was attempted to be opened previously. For example, a user can see if the tear strips 207 have been at least partially removed and/or if the tear lines 215, 217, 219 have been torn in the ends 233a, 233b of the lid part 107. Such tamper evidence may provide the user with an indication that the contents of the carton 109 may have been accessed prior to intended use.

In the illustrated embodiments, the handle 113 (e.g., a Wilton handle) can be formed by applying a handle panel 241 to an interior surface of the top panel 171 to at least partially extend along the handle opening 193 (FIGS. 5 and 8). As shown in FIGS. 4, 5, and 7, a handle strap 243 can be secured to the handle panel 241 so that the handle strap 243 is aligned in the handle opening 193 in the top panel 171. Accordingly, a user can grasp the handle strap 243 to lift the carton 109 at the handle 113. When grasping the handle 113 prior to an initial opening of the carton 109, the intact opening features 205a, 205b and the engaged locking flap 163 and locking panel 195 can hold the lid closed over the base part 103. Further, after the initial opening of the carton 109 as described above, the lid can be reclosed as described above. The carton 109 can be lifted at the handle 113 after the lid is reclosed and the locking panel 195 and the locking flap 163 can engage to hold the lid in the closed configuration during lifting. The handle 113 could be otherwise formed and/or the carton 109 could be otherwise grasped/carried/lifted without departing from the closure.

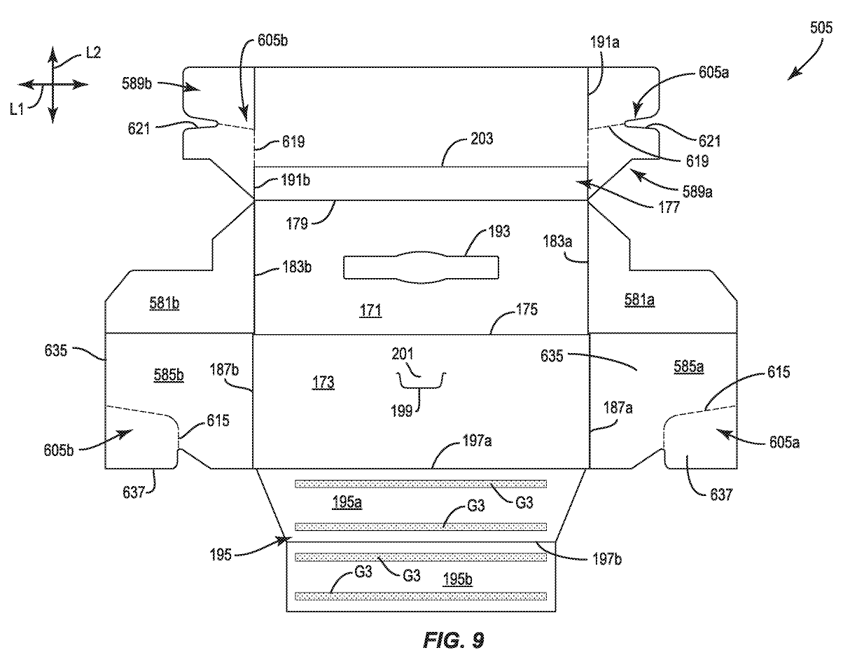

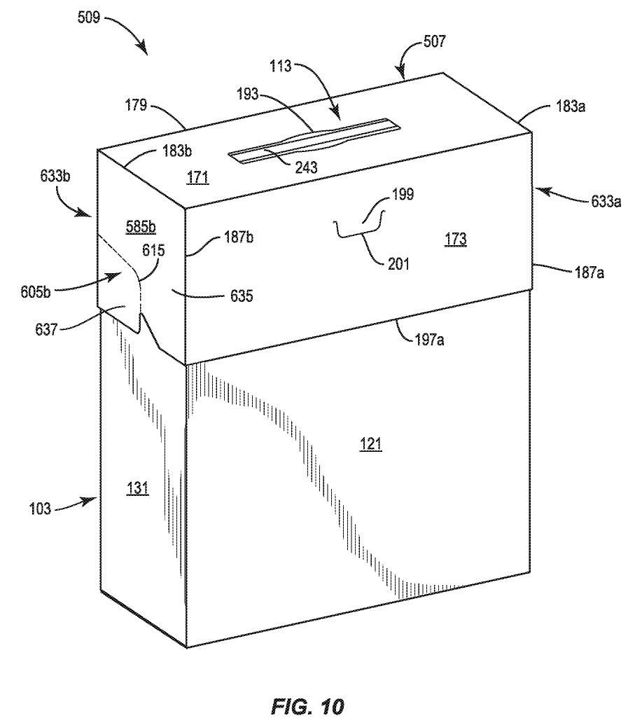

FIG. 9 is a plan view of a top blank 505 for forming a lid part 507 (FIGS. 10-12), which can cooperate with the base part 103 (FIG. 3) to form a container 509 (FIGS. 10-12) of a second embodiment of the disclosure. The second embodiment is generally similar to the prior embodiments, except for variations noted and variations that will be apparent to one of ordinary skill in the art. Accordingly, similar or identical features of the embodiments have been given like or similar reference numbers. As shown in FIG. 9, the top blank 505 is similar to the top blank 105 of FIG. 2 except that the top blank 505 has a different arrangement and configuration of lid end flaps and end panels for forming the ends 633a, 633b of the lid part 507. For example, the end panels 585a, 585b are foldably connected to the lid front panel 173 along the lateral fold lines 187a, 187b, and the top end flaps 581a, 581b are foldably connected to the top panel 171 along the lateral fold lines 183a, 183b. As shown in FIG. 9, the end panels 585a, 585b and the lid end flaps 581a, 581b, 589a, 589b have different shapes than the end panels and end flaps of the top blank 105 of FIG. 2. Further, the opening features 605a, 605b have a different arrangement and configuration than the opening features 205a, 205b of FIG. 2, and the glue strips G3 are applied to the lid locking panel 195 in the longitudinal direction L1 in FIG. 9 while the glue strips G2 are in the lateral direction L2 in the blank 105 of FIG. 2.

As shown in FIG. 9, the top blank 505 includes the top end flaps 581a, 581b foldably connected to the top panel 171 along respective lateral fold lines 183a, 183b and end panels 585a, 585b foldably connected to the lid front panel 173 along respective lateral fold lines 187a, 187b. In the illustrated embodiments, the second or removable portions 637 of the end panels 585a, 585b can be separable from the respective first or main portions 635 of the end panels 585a, 585b along respective tear lines 615 or other suitable lines of weakening. In addition to the tear lines 615 extending in the end panels 585a, 585b, the opening features 605a, 605b can include the tear lines 619, which can extend from respective ends of the hinge line 203 in the lateral direction L2 (e.g., collinear with the respective lateral fold lines 191a, 191b) and in the respective lid back end flaps 589a, 589b (e.g., from the respective fold lateral fold lines 191a, 191b to the respective cutouts 621). The top blank 505 could be otherwise shaped, arranged, and/or configured without departing from the disclosure.

As shown in FIG. 10, when the lid part 507 is formed, the top end flaps 581a, 581b and the lid back end flaps 589a, 589b are folded over the ends 633a, 633b of the lid part, the end panel 585a is folded over the end flaps 581a, 589a, and the end panel 585b is folded over the end flaps 581b, 589b. In embodiments, the main portions 635 of the end panels 585a, 585b can be attached (e.g., glued) to the respective top end flaps 581a, 581b and to the respective upper portions of the respective lid back end flaps 589a, 589b. Further, the removable portions 637 of the end panels 585a, 585b can be attached (e.g., glued) to the respective lower portions of the respective lid back end flaps 589a, 589b. In the illustrated embodiments, the lower portions of the lid back end flaps 589a, 589b and/or the removable portions 637 of the end panels 585a, 585b can be attached to the respective side panels 123, 131 of the base part 103 and the lid back panel 177 can be attached to the back panel 127 of the base part 103 to at least partially secure the lid part 507 to the base part 103 and form the carton 509 (FIG. 10), similarly to the prior embodiments.

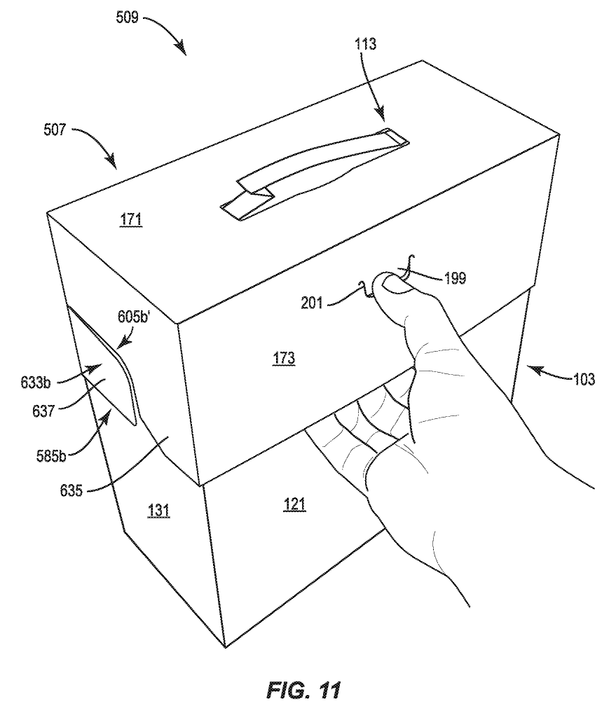

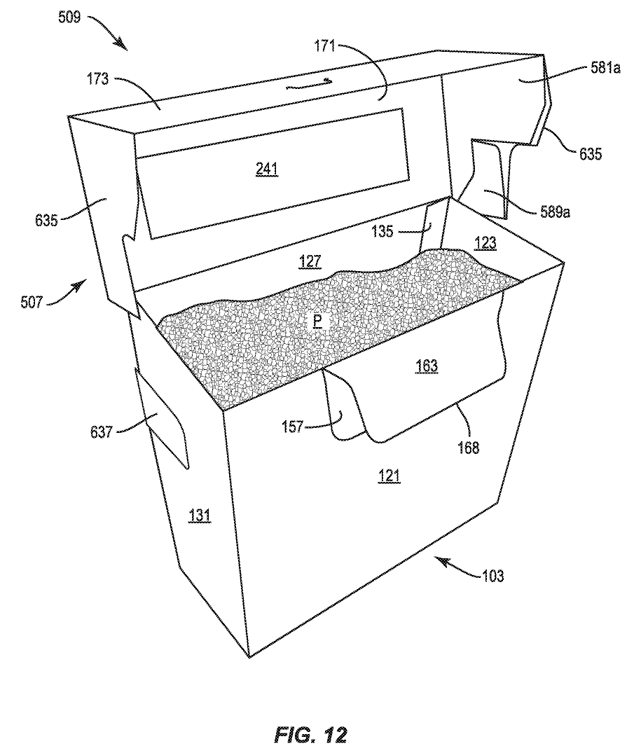

In embodiments, the opening features 605a, 605b can be actuated during an initial opening of the carton 509, such as by pulling outwardly on the main portions 635 of the end panels 585a, 585b to tear the end panels 585a, 585b along the respective tear lines 615 to separate the removable portions 637 from the main portions 635 of the end panels 585a, 585b. The actuating the opening features 605a, 605b can also tear the lid back end flaps 589a, 589b along the tear lines 619 to separate the upper portions from the lower portions of the lid back end flaps 589a, 589b. The lid then can be opened similarly to the prior embodiments by pressing inwardly on the tab 199 (FIG. 11) to disengage the locking flap 163 and the locking panel 195. Subsequently, the lid can be lifted to pivot the lid along the hinge line 203 and provide access to the interior of the carton 509 via the open top end 111 of the base part 103 (FIG. 12). In embodiments, the lid can be reclosed and/or can be carried by the handle 113 similarly to the prior embodiments. The carton 509 could be otherwise opened, closed, reopened, and/or reclosed without departing from the disclosure.

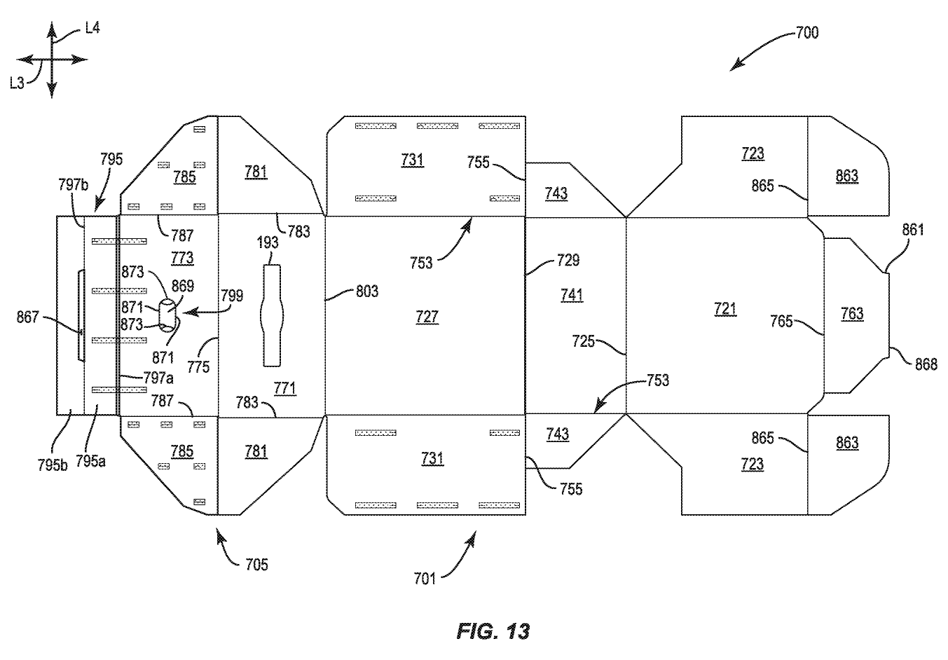

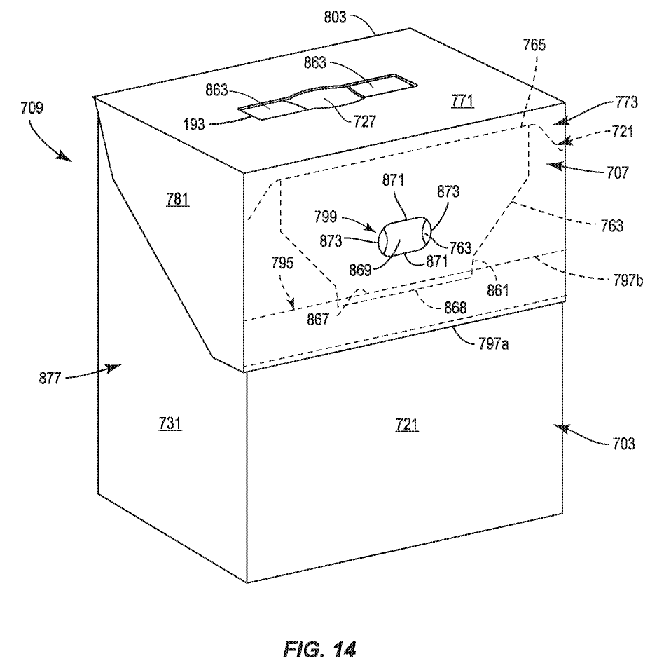

FIG. 13 is a plan view of a carton blank 700 for forming a carton 709 (FIGS. 14-17B) of a third embodiment of the disclosure. The third embodiment is generally similar to the prior embodiments, except for variations noted and variations that will be apparent to one of ordinary skill in the art. Accordingly, similar or identical features of the embodiments have been given like or similar reference numbers. As shown in FIG. 13, the blank 700 includes a base portion 701 and a lid portion 705, wherein the lid portion 705 is foldably connected to the back panel 727 of the base portion 701 along a hinge or lateral fold line 803. In the illustrated embodiments, the base portion 701 can at least partially form a first or base part 703 (e.g., a container portion) of the carton 709, and the lid portion 705 can at least partially form a second or lid part 707 of the carton 709 that is hinged to the base part 703 along the lateral fold line 803 (FIGS. 14-17B). In exemplary embodiments, the base part 703 and the lid part 707 can include locking and/or stop features for cooperating to resist/limit movement of the lid part 707 relative to the base part 703, as described in more detail below. In the illustrated embodiments, the blank 700 can be made of paperboard, cardboard, corrugated cardboard, and/or other suitable material(s). For example, the blank 700 can include a heavyweight and/or thick paperboard, multi-ply paperboard (e.g., Z-flute material available from Graphic Packaging International, LLC, of Atlanta, GA), micro-flute material, corrugated material, and/or combinations thereof. The blank 700 could be made of any suitable materials and/or combinations of materials without departing from the disclosure.

As shown in FIG. 13, the bottom blank 700 can have a longitudinal axis L3 and a lateral axis L4. In the illustrated embodiments, the bottom portion 701 of the blank 700 can include a front panel 721 foldably connected to a bottom panel 741 along a lateral fold line 725 and a back panel 727 foldably connected to the bottom panel 741 along a lateral fold line 729. The front panel 721 can be foldably connected to opposing front side panels 723, and the back panel 727 can be foldably connected to opposing back side panels 731. The bottom panel 741 can be foldably connected to opposing bottom flaps 743. As shown in FIG. 13, the side panels 723, 731 and the bottom flaps 743 can extend along respective marginal areas of the blank 700 and are foldably connected along respective longitudinal fold lines 753. The longitudinal fold lines 753 may be, for example, substantially straight, or offset at one or more locations to account for blank thickness and/or for other factors. In exemplary embodiments, the bottom flaps 743 can be separable from the respectively adjacent back side panels 731 along respective cut lines 755 or other suitable lines of weakening. Alternatively, the bottom flaps 743 and the back side panels 731 could be spaced apart from one another in the blank 700. Any of the panels 721, 723, 741, 727, 731 and/or the bottom flaps 743 could be omitted or could be otherwise shaped, arranged, configured, and/or positioned without departing from the disclosure.

As shown in FIG. 13, the bottom portion 701 can include a bottom locking flap 763 (e.g., of a bottom locking feature) foldably connected to the front panel 721 along a lateral fold line 765 opposite to the lateral fold line 725 at the bottom panel 741. In embodiments, the lateral fold line 765 can be configured to bias the bottom locking flap 763 outwardly away from the front panel 721 when the bottom locking flap 763 is folded downwardly toward the exterior surface of the front panel 721. In the illustrated embodiments, the bottom locking flap 763 can include a locking tab 861 that can extend along the distal edge 868 of the bottom locking flap 763, opposite to the fold line 765. In embodiments, the locking tab 861 can be shorter in the lateral direction L4 than the fold line 765. Longitudinal edges of the bottom locking flap 763 can extend from respective ends of the lateral fold line 765, and oblique edges of the bottom locking flap 763 can extend from the respective longitudinal edges to the locking tab 861. The bottom locking flap 763 and/or the locking tab 861 could be omitted or could be otherwise shaped, arranged, configured, and/or positioned without departing from the disclosure.

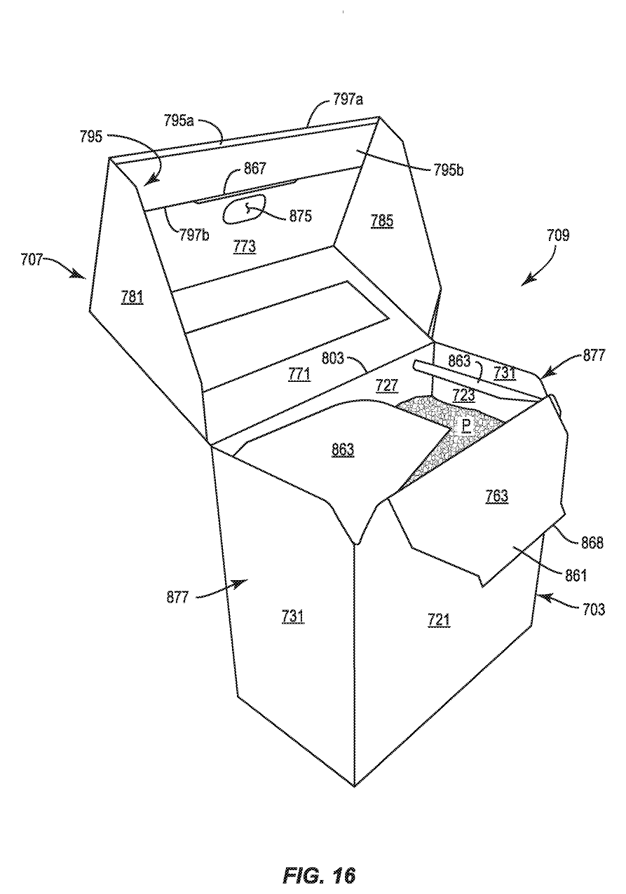

In the illustrated embodiments, the base portion 701 can include a dust flap or bias flap 863 foldably connected to the each of the front side panels 723 along respective lateral fold lines 865. In embodiments, the fold lines 865 can be configured to bias the bias flaps 863 upwardly away from the front side panels 723 when the bias flaps 863 are folded over the top end of the base part 703 (FIG. 16). The bottom locking flap 763, the locking tab 861, and/or the bias flaps 863 could be omitted or could be otherwise shaped, arranged, configured, and/or positioned without departing from the disclosure.

As shown in FIG. 13, the lid portion 705 of the blank 700 can include a top panel 771 that is foldably connected a lid front panel 773 along a lateral fold line 775 and to the back panel 727 along the lateral fold line 803. In the illustrated embodiments, the top panel 771 can be foldably connected to two opposing top end flaps 781 along respective lateral fold lines 783, and the lid front panel 773 can be foldably connected to two opposing lid front end flaps 785 along respective lateral fold lines 787. In embodiments, a handle opening 193 can extend in the top panel 771. Any of the top panel 771, the lid front panel 773, and/or the end flaps 781, 785 could be omitted or could be otherwise shaped, arranged, configured, and/or positioned without departing from the disclosure.

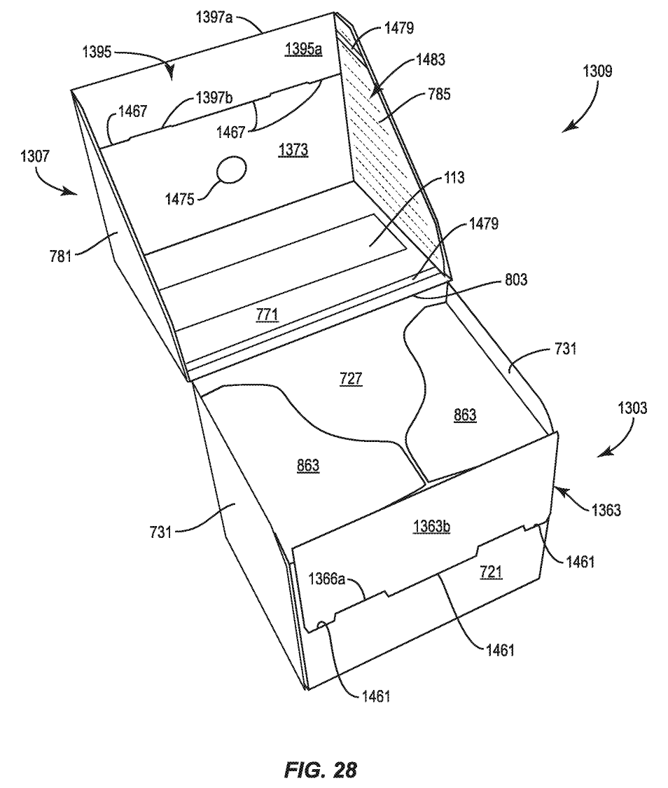

In the illustrated embodiments, the lid front panel 773 can be foldably connected to a lid locking feature, which can include a lid locking panel 795 foldably connected to the lid front panel 773 along a longitudinal fold line 797a. As shown in FIG. 28, the lid locking panel 795 can include a proximal portion 795a that is foldably connected to the lid front panel 773 along the fold line 797a and a distal portion 795b that is foldably connected to the proximal portion 795a along a lateral fold line 797b. When the lid 707 is formed, the portions 795a, 795b of the lid locking panel 795 can be folded along the lateral fold lines 797a, 797b into the interior of the lid 707 so that the lateral fold line 797b forms a lid locking edge. As shown in FIG. 13, an opening or slot 867 can extend in the lid locking panel 795 (e.g., can extend in the distal portion 795b, interrupting the fold line 797b). In embodiments, the opening 867 can be aligned with the locking tab 861 (e.g., in the lateral direction L4) and can be sized and shaped for at least partially receiving at least the locking tab 861 when the lid 707 is formed and in a closed configuration (FIG. 14). The lid locking feature could be omitted or could be otherwise shaped, arranged, configured, and/or positioned without departing from the disclosure.

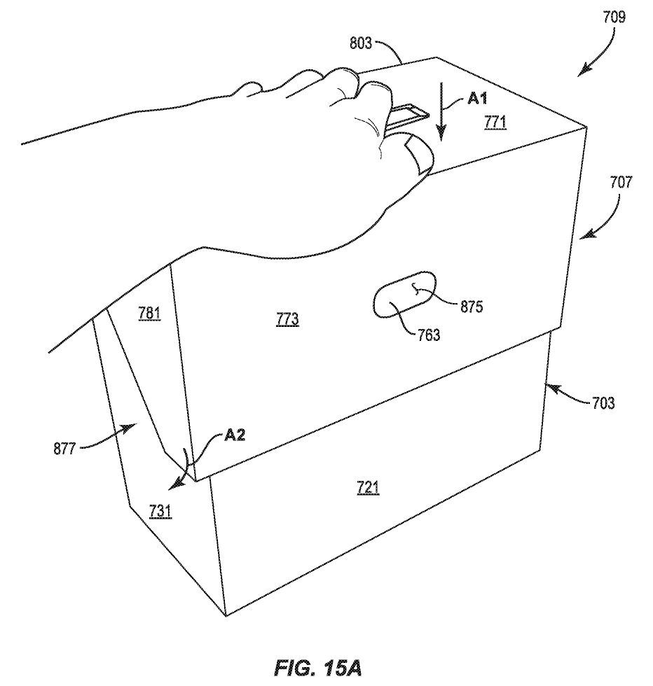

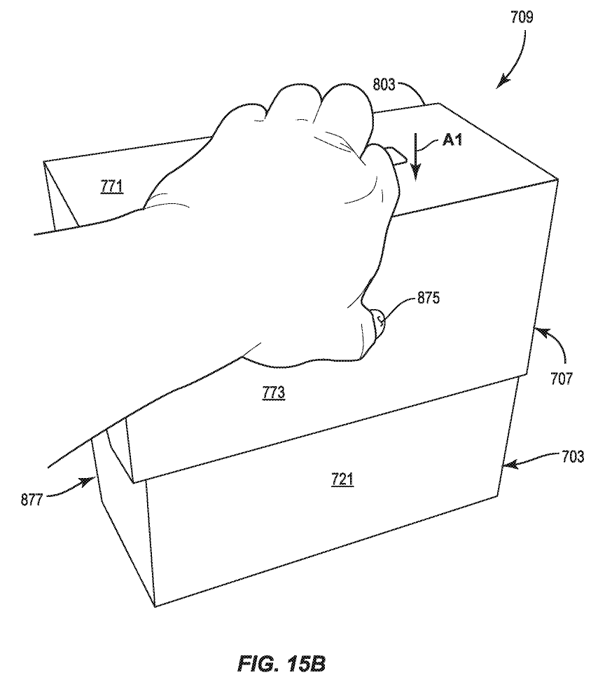

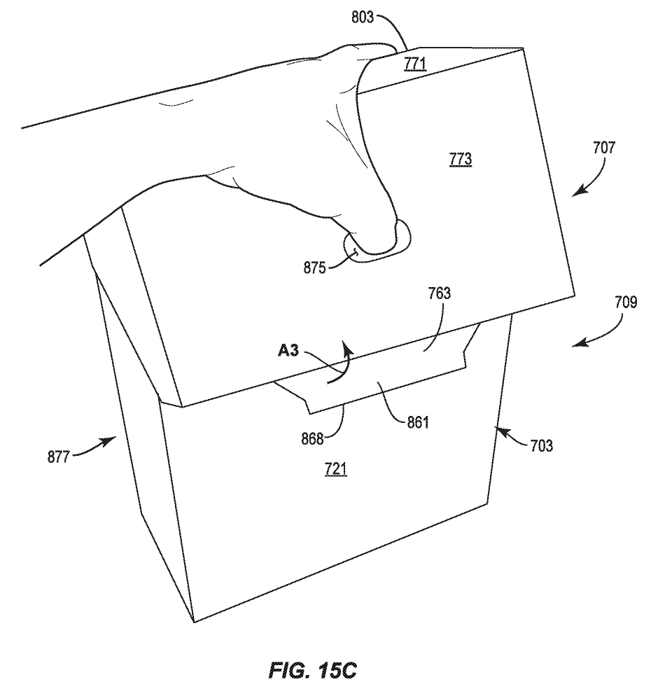

As shown in FIG. 13, an opening feature 799 can extend in the lid front panel 773. In embodiments, the opening feature 799 can include a tear-out panel 869 that can be separable from the lid front panel 773 along two tear lines 871 and/or other suitable lines of weakening. In the illustrated embodiments, the opening feature 799 can include two apertures 873 at opposing ends of the tear-out panel 869 for grasping the tear-out panel 869 and tearing it away from the lid front panel 773 when initially opening the carton 709. In exemplary embodiments, the at least partial removal of the tear-out panel 869 can provide visual evidence that the carton 709 has been opened and/or tampered with (e.g., tamper evident features). Once the tear-out panel 869 is removed, an access opening 875 is formed in the lid front panel 773 (FIGS. 15A-17B). The opening feature 799 could be omitted or could be otherwise shaped, arranged, configured, and/or positioned without departing from the disclosure.

The carton blank 700 could be otherwise shaped, arranged, and/or configured without departing from the disclosure.

As shown in FIG. 14, the carton 709 can be formed from the blank 701 by folding the base panels 721, 741, 727 along the lateral fold lines 725, 729 to extend at least partially around an interior of the carton 709 (e.g., an interior of the base portion 703) and folding the side panels 723, 731 and the bottom flaps 742 over the respective ends of the base part 703 to form respective end walls 877 of the base part 703 (FIGS. 14-17B). In embodiments, the bottom flaps 743 and the front side panels 723 can be overlapped with and glued to the respective back side panels 731 (e.g., glued in face-to-face contact with glue, for example, which can be applied to the interior surface of the back side panels 731 and/or to the exterior surfaces of the front side panels 723 and the bottom flaps 743) to form the end walls 877. As shown in FIG. 16, the bottom locking flap 763 can be folded outwardly along the lateral fold line 765 toward the exterior surface of the front panel 721 (e.g., with the lateral fold line 765 biasing the bottom locking flap 763 outwardly away from the front panel 721), and the bias flaps 863 can be folded over the open top end 711 of the base part 703 in the interior of the carton 709 (e.g., with the lateral fold lines 865 biasing the bias flaps 863 upwardly, away from the interior of the base portion 703).

In the illustrated embodiments, the lid part 707 can be formed by folding the lid locking panel 795 along the lateral fold line 797b to position the portions 795a, 795b in overlapping relationship (e.g., gluing the portions 795a, 795b together in face-to-face contact, such as with glue strips) and folding the lid locking panel 795 into overlapping relationship with the lid front panel 773 (e.g., gluing the lid locking panel 795 in face-to-face contact with the interior surface of the lid front panel 773, such as with glue strips). In exemplary embodiments, the distal portion 795b can be sandwiched between the lid front panel 773 and the proximal portion 795a. The lid part 707 can be further formed by folding the lid front panel 773 with respect to the top panel 771 along the lateral fold line 775 (e.g., so that the lid front panel 773 is perpendicular with the top panel 771), and folding the end flaps 781, 785 over the respective ends of the lid part 707 in overlapping relationships (e.g., gluing the interior surfaces of the end panels 781 in face-to-face contact with the exterior surfaces of the respective end panels 785, such as with glue strips applied to the exterior surfaces of the end flaps 785 and/or the interior surfaces of the end flaps 781).

The carton 709 could be otherwise formed without departing from the disclosure. Similarly, the base part 703 and the lid part 707 could be otherwise formed without departing from the disclosure.

In the illustrated embodiments, when the carton 709 is in the erected and closed configuration (FIG. 14), the bottom locking flap 763 and the lid locking panel 795 can cooperate to resist opening of the carton 709 (e.g., can resist pivoting the lid part 707 relative to the base part 703). For example, the outward bias of the bottom locking flap 763 can cause at least a portion of the bottom locking flap 763 (e.g., the distal edge 868 of the bottom locking flap) to engage (e.g., to be pressed against) the interior surface of the lid front panel 773 proximate the lid locking panel 795, and the upward bias of the bias flaps 863 can cause the bias flaps 863 to engage (e.g., to be pressed against) the interior surface of the top panel 771). In embodiments, the bias flaps 863 can press upwardly on the lid part 707 to bias the lid part 707 upwardly toward engagement between the lid locking panel 795 and the bottom locking flap 763. As shown in FIG. 14, the locking tab 861 of the bottom locking flap 763 can be at least partially received in the opening 867 in the lid locking panel 795. In embodiments, the engagement between the lid locking panel 795 and the bottom locking flap 763 can resist pivoting of the lid part 707 relative to the base part 703, such as when attempting to open the lid part 707 and/or lifting the carton 709 at the handle 113.

As shown in FIGS. 15A-15C, the carton 709 can be opened by following certain steps to disengage the locking features of the carton 709. For example, the tear-out panel 869 can be removed from the lid front panel 773 to form the access opening 875, making the bottom locking flap 763 accessible from the exterior of the lid part 707. However, in embodiments, pressing inwardly on the bottom locking flap 763 via the access opening 875 does not disengage the bottom locking flap 763 and the lid locking flap 795 because the locking tab 861 is received in the opening 867, which can resist the bottom locking flap 763 from pivoting inwardly relative to the lid locking panel 795. As shown in FIG. 15A, the lid part 707 can be pressed downwardly as shown by downward arrow A1 (e.g., pivoting along the lateral fold line 803, as shown by curved arrow A2) so that the lid locking panel 795 moves below the distal edge 868 of the bottom locking flap 763 so that the locking tab 861 is moved out of the opening 867. Since the bottom locking tab 763 is biased outwardly and the lid part 707 is biased upwardly by the bias flaps 863, releasing the lid part 707 at this point would result in the lid part moving back to the position shown in FIG. 14 and the bottom locking flap 763 and the lid locking panel 795 reengaging with one another.

As shown in FIG. 15B, the bottom locking flap 763 can be pressed inwardly via the access opening 875 while pressing the lid part 707 downwardly to the position shown in FIGS. 15A and 15B. As shown in FIG. 15C, the lid part 707 can be pivoted upwardly along the fold line 803 (e.g., as shown by the curved arrow A3) while pressing inwardly on the bottom locking flap 763 via the access opening 875 to prevent the bottom locking flap 763 from engaging the lid locking panel 795 to open the carton 709. The carton 709 is shown in the open configuration in FIG. 16, for example.

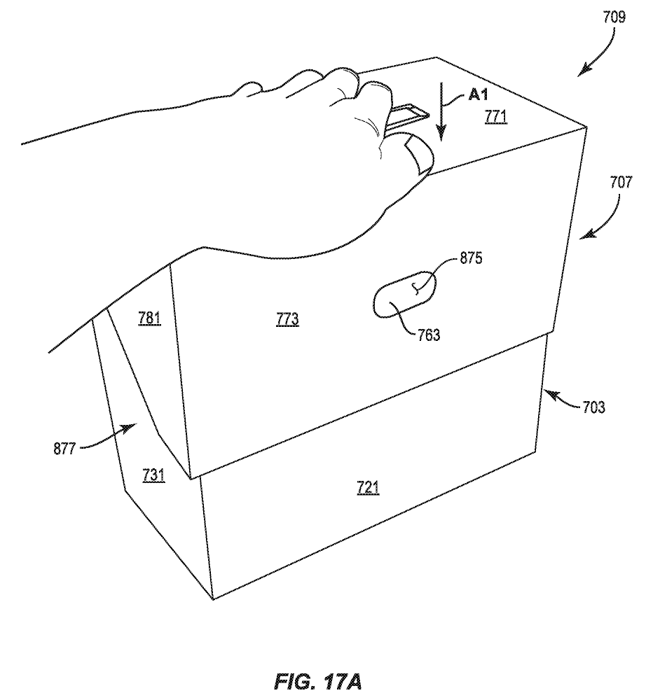

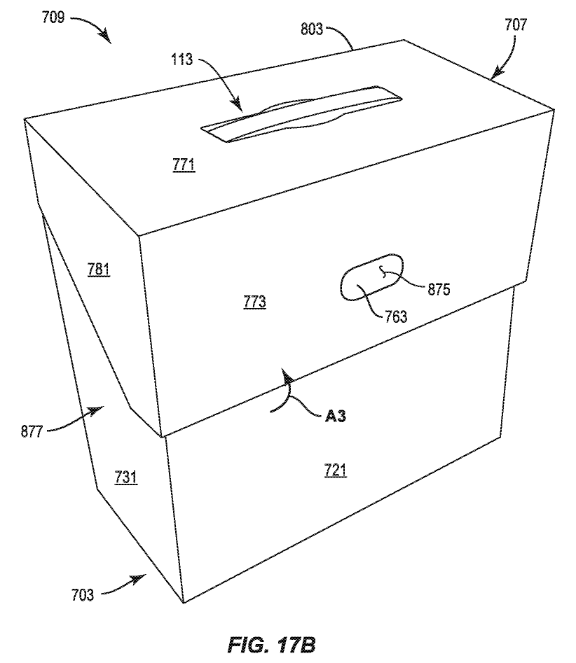

In the illustrated embodiments, the carton 709 can be returned to the closed and locked configuration of FIG. 14 by pivoting the lid part 707 downwardly over the base part 703 as shown in FIG. 17A. As shown in FIG. 17A, the lid part 707 is pushed downwardly past the closed position of FIG. 14 so that the lid locking panel 795 moves below the distal edge 868 of the bottom locking flap 763 (e.g., to the position or approximately the position of FIG. 15B). In exemplary embodiments, the bottom locking flap 763 can make an audible noise (e.g., a “click”) when the bottom locking flap 763 moves past the lid locking panel 795 and snaps outwardly against the inner surface of the lid front panel 773 (e.g., due to the outward bias of the bottom locking flap 763).

As shown in FIG. 17B, the lid part 707 can be released from the position in FIG. 17A (e.g., by releasing the downward pressure in the direction of arrow A1), and the upward bias of the biasing flaps 863 can cause the biasing flaps 863 to push the lid part 707 upwardly so that the lid part 707 pivots upwardly in the direction of curved arrow A3 about the fold line 803 to the closed and locked position of FIG. 14. As discussed above, the bottom locking flap 763 and the lid locking panel 795 can reengage (e.g., so that the locking tab 861 is at least partially received in the opening 867). The carton 709 can be reopened by following the unlocking steps (e.g., the two-step unlocking procedure) discussed above. The carton 709 could be otherwise opened and/or closed without departing from the disclosure.

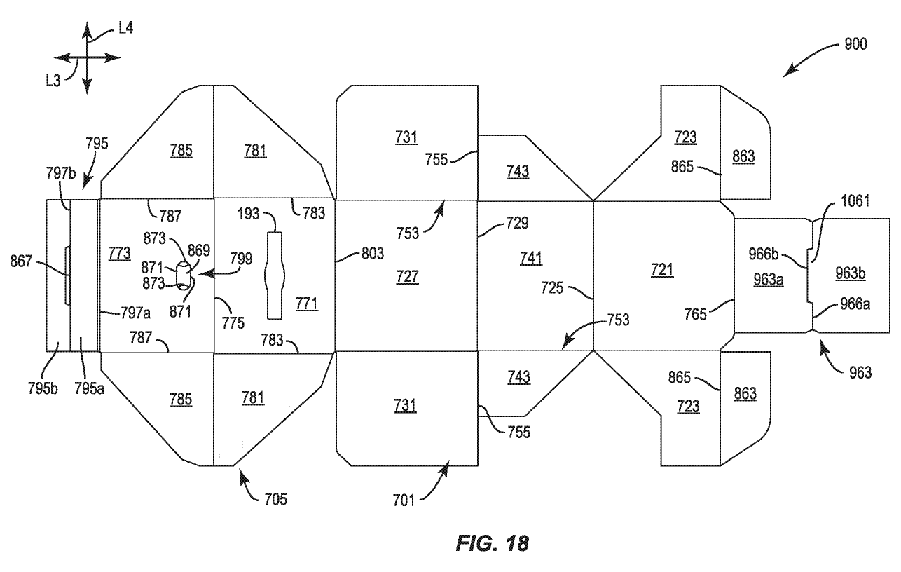

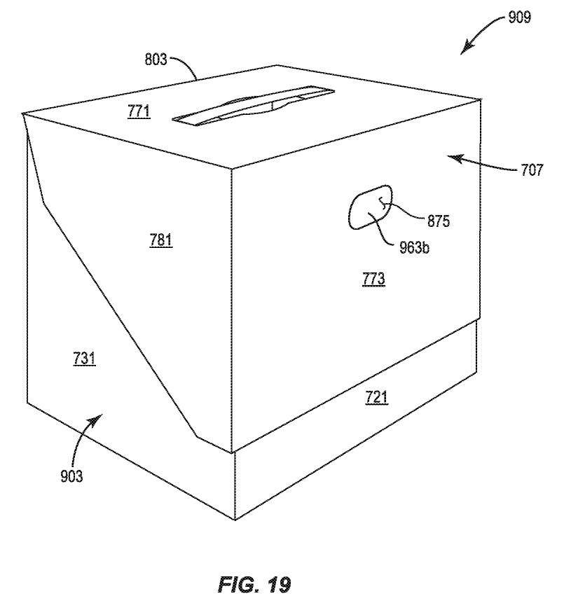

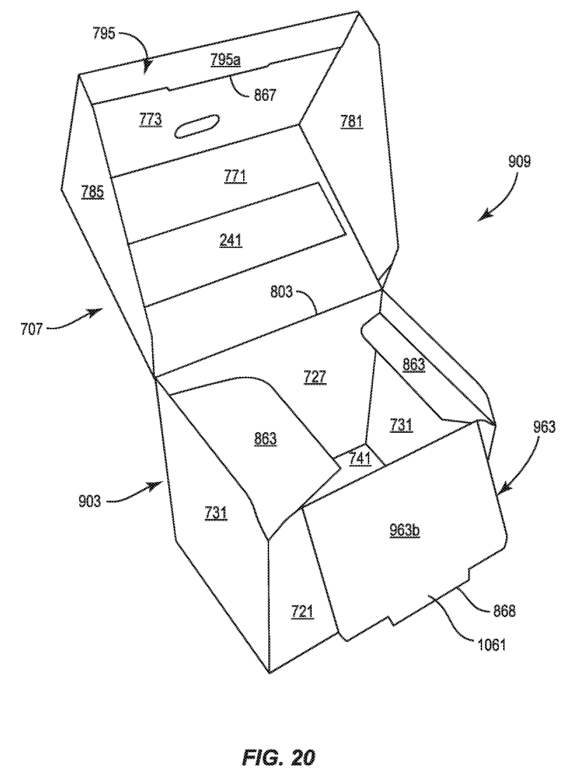

FIG. 18 is a plan view of a carton blank 900 for forming a carton 909 (FIGS. 19 and 20) of a fourth embodiment of the disclosure. The fourth embodiment is generally similar to the prior embodiments, except for variations noted and variations that will be apparent to one of ordinary skill in the art. Accordingly, similar or identical features of the embodiments have been given like or similar reference numbers. As shown in FIG. 18, the blank 900 can be similar to the blank 700 of FIG. 13 except that the panels and flaps that form the bottom portion 701 and the top portion 705 of the blank 900 can have different sizes/proportions than the same flaps and panels in the blank 700. Further, the locking feature of the bottom portion 701 in the blank 900 can include a different bottom locking flap 963. As shown in FIG. 18, the bottom locking flap 963 can include a proximal portion 963a that is foldably connected to the base front panel 721 along the lateral fold line 765 and a distal portion 963b that is foldably connected to the proximal portion 963a along a lateral fold line 966a. In the illustrated embodiments, a locking tab 1061 can extend from the distal portion 963b along the proximal portion 963a and can be separable from the proximal portion 963a along a cut line 966b or another line of weakening. In embodiments, the locking tab 1061 and the cut line 966b can be centered in the bottom locking flap 963 in the lateral direction L4 and can interrupt the fold line 966a. The blank 900 could be otherwise shaped, arranged, and/or configured without departing from the disclosure.

In the illustrated embodiments, the carton 909 (FIG. 19) can be formed from the blank 900 in a similar manner as the carton 709 is formed as described above. In exemplary embodiments, the bottom locking flap 963 can be formed by folding the distal portion 963b of the bottom locking flap 963 into face-to-face contact with the proximal portion 963a (e.g., gluing and/or otherwise securing the portions 963a, 963b together). As shown in FIG. 20, the bottom locking flap 963 is biased outwardly along the fold line 765, away from the base front panel 721, and the locking tab 1061 extends outwardly from the fold line 966a. Similarly to the prior embodiment, the locking tab 1061 is at least partially received in the slot 867 in the lid locking panel 795 when the bottom locking flap 963 and the lid locking panel 795 are engaged in the closed configuration of the carton 909. In embodiments, the carton 909 can be opened and closed in a similar or identical manner as the carton 709 as described above. The carton 909 could be otherwise formed and/or could be otherwise opened and/or closed without departing from the disclosure.

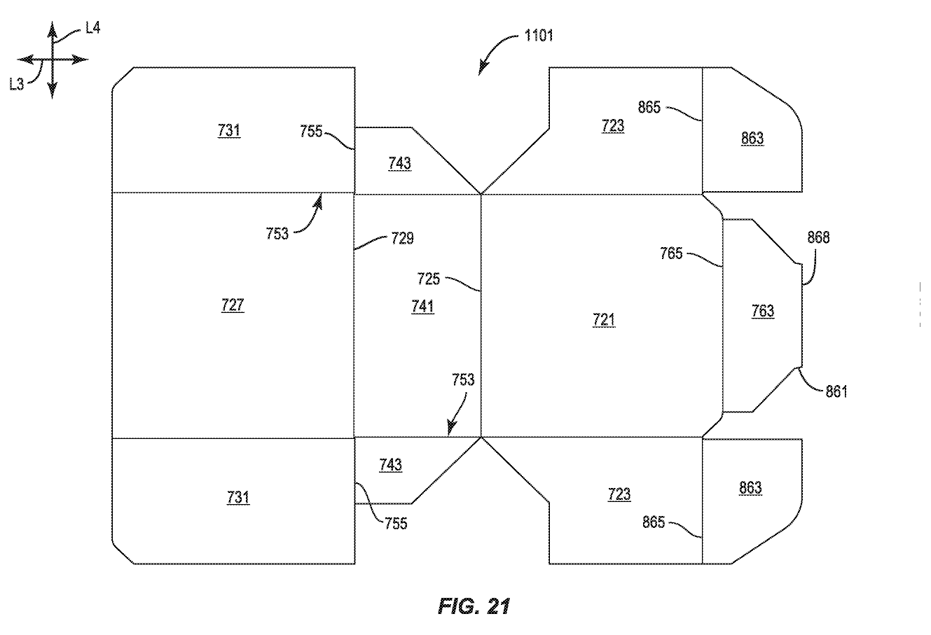

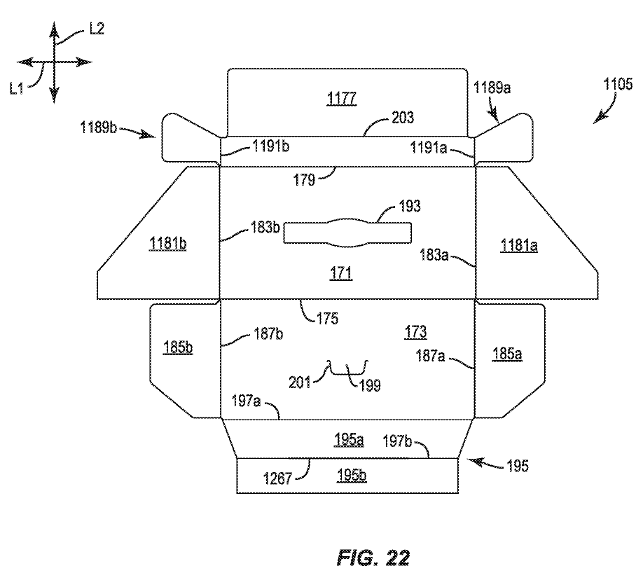

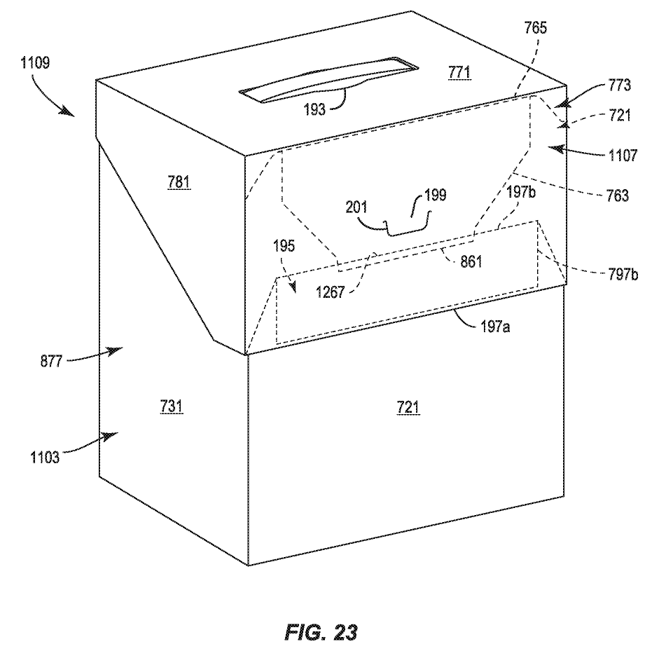

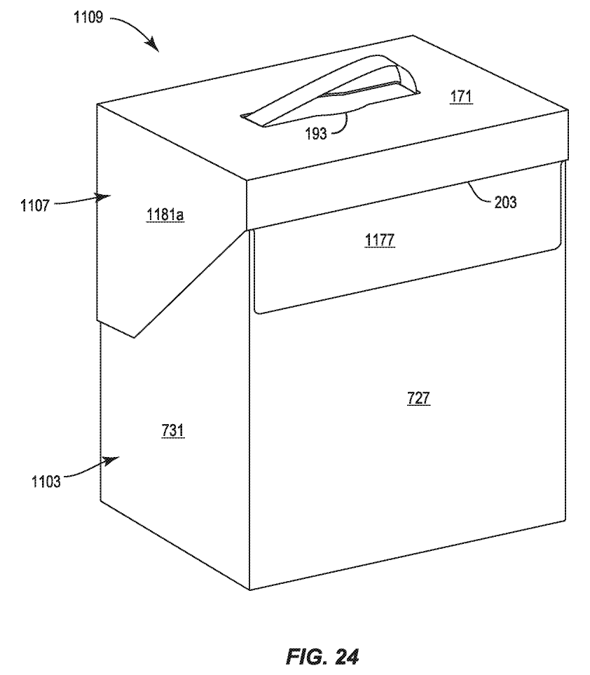

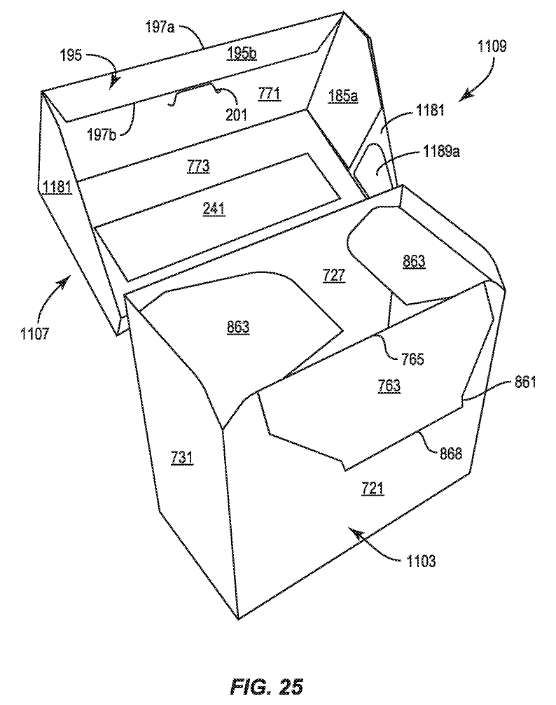

FIGS. 21 and 22, respectively, are a plan view of a bottom blank 1101 and a plan view of a top blank 1105 for forming a carton 1109 (FIGS. 23-25) of a fifth embodiment of the disclosure. The fifth embodiment is generally similar to the prior embodiments, except for variations noted and variations that will be apparent to one of ordinary skill in the art. Accordingly, similar or identical features of the embodiments have been given like or similar reference numbers. As shown in FIG. 21, the bottom blank 1101 can be similar to the bottom portion 701 of the blank 700 shown in FIG. 13 and can form a bottom part 1103 (FIGS. 23-25) that is similar to the bottom part 703 of the prior embodiment.

As shown in FIG. 22, the top blank 1105 can be similar to the top blanks of the prior embodiments (e.g., can be similar to the top blank 105 shown in FIG. 2 without the initial opening features 205a, 205b) and can form a top part 1107 (FIGS. 23-25) that is similar to the top parts of the prior embodiments. In the illustrated embodiments, the top blank 1105 can include end panels 781 foldably connected to opposite ends of the top panel 171 along fold lines 183, front end flaps 1185 foldably connected to opposite ends of the lid front panel 173 along fold lines 187, and back end flaps 1189 foldably connected to opposite ends of the lid back panel 1177 along fold lines 1181. In embodiments, the end panels 781 and the end flaps 1185, 1189 can be at least partially overlapped to at least partially close the ends of the lid part 1109 (FIGS. 23-25). As shown in FIG. 22, the locking features can include a slit or cut 1267 extending along at least a portion of the fold line 197b. The bottom blank 1101 and/or the top blank 1105 could be otherwise shaped, arranged, and/or configured without departing from the disclosure.

In embodiments, the carton 1109 can be formed in a similar manner as in the prior embodiments, and the resulting carton can include the top part 1107 attached to the bottom part 1103, such as by gluing the lid back panel 1177 to the back panel 727 of the bottom part 1103. As shown in FIGS. 23-25, the bottom blank 1101 and the top blank 1105 can form a carton 1109 with locking features that resist opening of the carton in a similar or identical manner as the locking features of the prior embodiments. For example, as schematically shown in FIG. 23, the locking tab 861 extending from the bottom locking flap 763 can be at least partially received in the cut 1267 when the carton 1109 is in the closed configuration and the locking features are engaged. In addition, the carton 1109 formed from the bottom blank 1101 and the top blank 1105 can be opened by manipulating the locking features as described above in the prior embodiments (e.g., as described above for the carton 709 shown in FIGS. 14-17B). The carton 1109 could be otherwise shaped, arranged, and/or configured without departing from the disclosure.

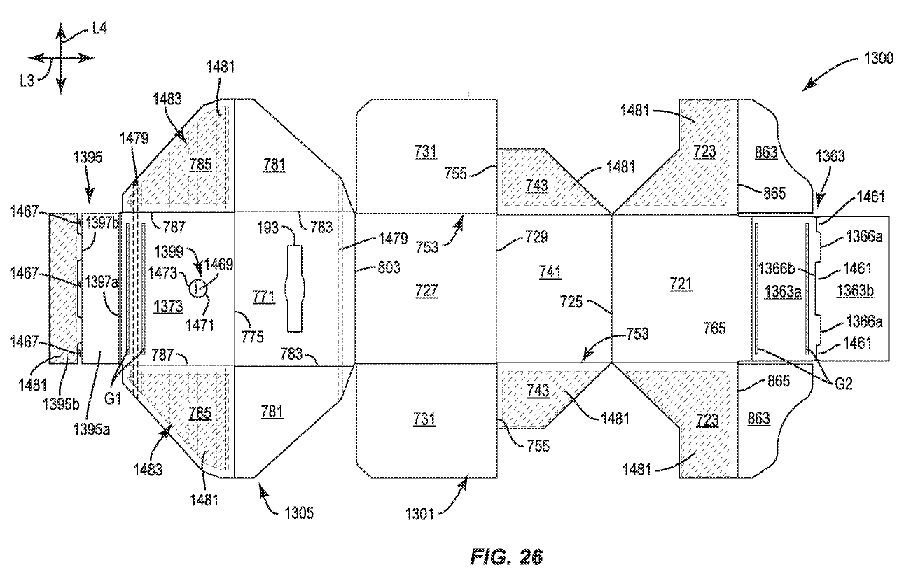

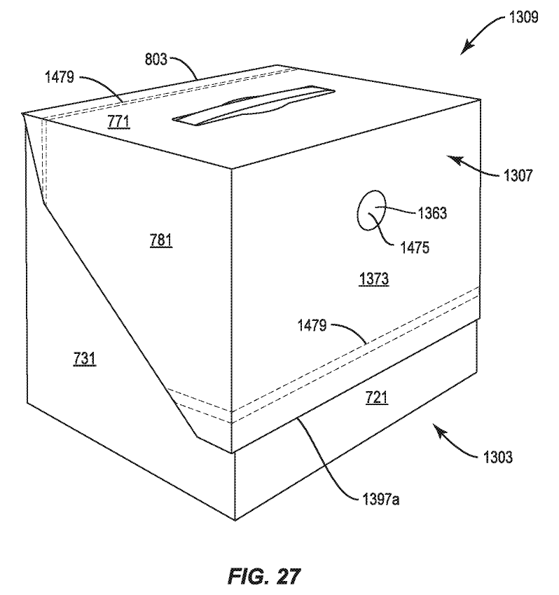

FIG. 26 is a plan view of a carton blank 1300 for forming a carton 1309 (FIGS. 27-30) of a fifth embodiment of the disclosure. The fifth embodiment is generally similar to the prior embodiments, except for variations noted and variations that will be apparent to one of ordinary skill in the art. Accordingly, similar or identical features of the embodiments have been given like or similar reference numbers. As shown in FIG. 26, the blank 1300 can be similar to the blank 700 of FIG. 13 and the blank 900 of FIG. 18 except that the panels and flaps that form the bottom portion 1301 and the top portion 1305 of the blank 1300 can have different sizes/proportions and/or different shapes than the same flaps and panels in the blanks 700, 900. As shown in FIG. 26, the blank 1300 can have a different lid locking panel 1395 and a different bottom locking flap 1363 than in prior embodiments, and the blank 1300 can include reinforcing features to further resist or prevent opening of the carton 1309.

As shown in FIG. 26, the bottom locking flap 1363 can include a proximal portion 1363a that is foldably connected to the base front panel 721 along the lateral fold line 765 and a distal portion 1363b that is foldably connected to the proximal portion 1363a along two spaced lateral fold lines 1366a (e.g., colinear fold lines). In the illustrated embodiments, one or more locking tabs 1461 (e.g., three locking tabs) can extend from the distal portion 1363b along the proximal portion 1363a and can be separable from the proximal portion 1363a along cut lines 1366b or other lines of weakening. In the illustrated embodiments, the distal portion 1395b of the lid locking panel 1395 can be foldably connected to the proximal portion 1395a along lateral fold lines 1397b, and one or more openings or slots 1467 (e.g., three slots) can extend in the distal portion 1395b along the proximal portion 1395a. In embodiments, the lateral fold lines 1397b can extend between respectively adjacent slots 1467, and the slots 1467 can be at least partially aligned with the respective locking tabs 1461 defined in the bottom locking flap 1363 along the longitudinal direction L3. In embodiments, the slots 1467 can be sized and shaped for at least partially receiving the respective locking tabs 1461 when the lid 1307 is formed and in a closed configuration (FIGS. 27, 29 and 30). The bottom locking flap 1363 and/or the lid locking panel 1395 could be omitted or could be otherwise shaped, arranged, configured, and/or positioned without departing from the disclosure.

In the illustrated embodiments, an unlocking feature/opening feature 1399 can extend in the lid front panel 1373. In exemplary embodiments, the opening feature 1399 can be round (e.g., a circle or oval shape). In embodiments, the opening feature 1399 can include a tear-out panel 1469 that can be separable from the lid front panel 1373 along a curved tear line 1471 and/or other suitable lines of weakening. In the illustrated embodiments, the opening feature 1399 can include an aperture 1473 for grasping the tear-out panel 1469 and tearing it away from the lid front panel 1373 when initially opening the carton 1309. In exemplary embodiments, the at least partial removal of the tear-out panel 1469 can provide visual evidence that the carton 1309 has been opened and/or tampered with (e.g., tamper evident features). Once the tear-out panel 1469 is removed, an access opening 1475 is formed in the lid front panel 1373 (FIGS. 27-30). The unlocking feature/opening feature 1399 could be omitted or could be otherwise shaped, arranged, configured, and/or positioned without departing from the disclosure.

In the illustrated embodiments, the reinforcing features of the blank 1300 can include one or more reinforcement strips 1479 (e.g., two strips 1479) applied to a surface (e.g., the interior surface) of the blank 1300. For example, the reinforcement strips 1479 can be a strip of material (e.g., a tape) that can be adhered to the interior surface of the blank 1300 (e.g., an adhesive tape) along selected portions of the blank 1300 for reinforcing aspects of the blank 1300. As shown in FIG. 26, the reinforcement strips 1479 can be applied to the top panel 771 and the top end flaps 781 and to the lid front panel 1373 and the lid front end flaps 785 so that the reinforcement strips 1479 extend along the lateral direction L4. In embodiments, the reinforcements strips 1479 can polymer tapes, metallic tapes, tapes with reinforcing fibers, composites, laminates, etc. for reinforcing the material of the blank 1300. For example, the reinforcement strips 1479 could be “tear tape” that is often applied along tear-away strips of a carton dispenser (not shown). In exemplary embodiments, the reinforcement strips 1479 can help reinforce the lid at or adjacent its hinge (lateral fold line 803) and along the lid locking feature (along the folded lid locking panel 1395) when the lid 1305 is formed. FIG. 27 shows the exterior of the carton 1309 and shows the reinforcement strips 1479 in dashed lines to indicate the locations of the reinforcement strips on the interior of the carton. Any of the reinforcement strips 1479 could be omitted or could be otherwise shaped, arranged, configured, and/or positioned without departing from the disclosure.

As shown in FIG. 26, the reinforcing features further can include surface features on the blank 1300 that can facilitate forming a stronger bond between portions of the carton 1309 when adhering the portions together. For example, the blank 1300 can include uncoated areas 1481 (e.g., the cross-hatched areas schematically shown in FIG. 26) on a surface of the bottom flaps 743, the front side panels 723, the lid front end flaps 785, and the distal portion 1395b of the lid locking panel 1395. In embodiments, the uncoated areas 1481 can provide a better surface for receiving adhesive (e.g., a fibrous/porous surface) to assist in bonding the respective panel/flaps to other portions of the carton 1305. The surface features further can include a glue assist feature 1483 on each of the lid front end flaps 785. For example, the glue assist features 1483 can include a plurality of cuts arranged in a series of lines (e.g., about 0.125 inch (3.175 mm) long cuts spaced apart by about 0.125 inch (3.175 mm) in respective lines), and the cuts can be partial cuts and/or cuts that extend 100% through the material. In the illustrated embodiments, the lines of cuts can extend in the lateral direction L4. Alternatively, the cuts could be arranged in any suitable configuration or direction. In embodiments, the cuts can facilitate forming a stronger bond between the lid front end flaps 785 and the top end flaps 781 when the lid 1305 is formed such as by engaging more adhesive with the lid front end flaps 785 (e.g., a larger amount of glue can be in contact with the material of the lid front end flaps 785 via the cuts).

In embodiments, the blank 1300 can be formed of a paper-based corrugated material and/or other suitable material(s). In exemplary embodiments, the material of the blank 1300 can be an E-flute material and/or can have any other suitable fluting. While the blank material could be a 200# material in certain applications, the present embodiments can be formed from a 250# material, which can further strengthen the carton and its locking features (e.g., so that the carton is even more resistant to opening such as by a child). In one embodiment, the blank material could be ZFLUTE^{TM} reinforced packaging material, corrugated packaging material, or other suitable reinforced packaging material without departing from the disclosure. The blank 1300 could be otherwise shaped, arranged, and/or configured without departing from the disclosure.

In the illustrated embodiments, the carton 1309 (FIG. 27-30) can be formed from the blank 1300 in a similar manner as the cartons 709, 909 are formed as described above. In embodiments, the lid locking panel 1395 can be folded along the lateral fold lines 1397b to position the portions 1395a, 1395b in overlapping relationship. In embodiments, the portions 1395a, 1395b can remain unglued to one another. Alternatively, the portions 1395a, 1395b can be glued together in face-to-face contact, such as with glue strips G1. As shown in FIGS. 28, the lid locking panel 1395 can be folded into overlapping relationship with the lid front panel 1373 (e.g., gluing the lid locking panel 1395 in face-to-face contact with the interior surface of the lid front panel 1373, such as with glue strips G1). For example, the glue strips G1 can extend in the lateral direction and can be aligned on either side of the reinforcement strip 1479. The lid locking panel 1395 can be attached to the lid front panel 1373 so that the uncoated area 1481 of the distal portion 1395b is in face-to-face contact with the lid front panel 1373 and is secured to the lid front panel 1373 by the glue strips G1. In embodiments, the length of the glue strips G1 and the uncoated area 1481 can help form a strong bond between the lid locking panel 1395 and the lid front panel 1373 to help resist separation of the panels (e.g., to help prevent tearing open the locking features of the carton 1309). When the lid locking panel 1395 is secured to the lid front panel 1373, the slots 1467 can form recesses or receiving spaces between the lid front panel 1373 and the proximal portion 1395a of the lid locking panel 1395.

In exemplary embodiments, the bottom locking flap 1363 can be formed by folding the distal portion 1363b of the bottom locking flap 1363 into face-to-face contact with the proximal portion 1363a. For example, the portions 1363a, 1363b can be glued and/or otherwise secured together, such as with glue strips G2 on the proximal portion 1363a and/or on the distal portion 1363b. In embodiments, the glue strips G2 can extend across the bottom locking flap 1363 in the lateral direction (e.g., from approximately one edge to approximately the opposing edge) to help secure the portions 1363a, 1363b together and to help resist separation of the portions 1363a, 1363b. Alternatively, the glue G2 could be otherwise applied. As shown in FIG. 28, the bottom locking flap 1363 can be folded along the fold line 765 over the exterior of the front panel 721, and the locking tabs 1461 can extend outwardly from the fold lines 1366a. In some embodiments, the bottom locking flap can be biased outwardly along the fold line 765, away from the base front panel 721.

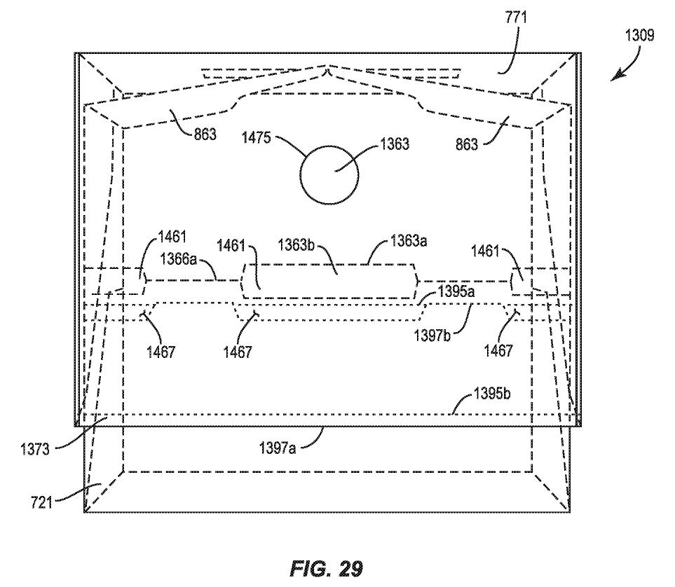

In the illustrated embodiments, when the carton 1309 is in the erected and closed configuration (FIGS. 27 and 29), the bottom locking flap 1363 and the lid locking panel 1395 can cooperate to resist opening of the carton 1309 (e.g., can resist pivoting the lid part 1307 relative to the base part 1303). For example, the bottom locking flap 1363 can be biased outwardly or otherwise caused to move the locking tabs 1461 against the interior surface of the lid front panel 773, and the bias flaps 863 can be biased upwardly to engage (e.g., to be pressed against) the interior surface of the top panel 771. In embodiments, the bias flaps 863 can press upwardly on the lid part 1307 to bias the lid part 1307 upwardly toward engagement between the lid locking panel 1395 and the bottom locking flap 1363. Further, the bias flaps 863 are configured to increase the rigidity and stiffness of the carton 1309 by providing resistance to inward deformation of the side panels 723, 731, front pane 721, and/or back panel 727. When the lid locking panel 1395 and the bottom locking flap 1363 are engaged, the locking tabs 1461 of the bottom locking flap 1363 can be at least partially received in the respective slots 1467 in the lid locking panel 1395. In embodiments, the engagement between the lid locking panel 1395 and the bottom locking flap 1363 can resist pivoting of the lid part 1307 relative to the base part 1303, such as when attempting to open the lid part 1307 and/or lifting the carton 1309 at the handle. In addition, when the locking tabs 1461 are received in the respective slots 1467, the locking panels can resist separation in the horizontal direction (e.g., if the lid front panel 1373 is pulled outwardly and/or the bottom locking flap 1363 is pushed inwardly, such as via an access opening 1475 in the lid front panel 1373, in an effort to bypass the locking features without pressing down on the lid 1307 first). In embodiments, the use of multiple locking tabs 1461 and multiple slots 1467 spread across the width of the carton 1309 and bottom locking flap 1363 and lid locking panel 1395 can help distribute the resistance to opening of the carton 1309, which can help to better lock the carton 1309 than if the locking features were only centered in the front of the carton, for example. As shown in FIG. 29 a respective locking tab 1461 of the bottom locking flap 1363 is aligned with a respective locking opening/slot 1467 in the lid locking panel 1395 so that the respective locking tab engages the respective locking slot 1467 if the lid part 1307 is attempted to be raised without disengagement of the locking features.

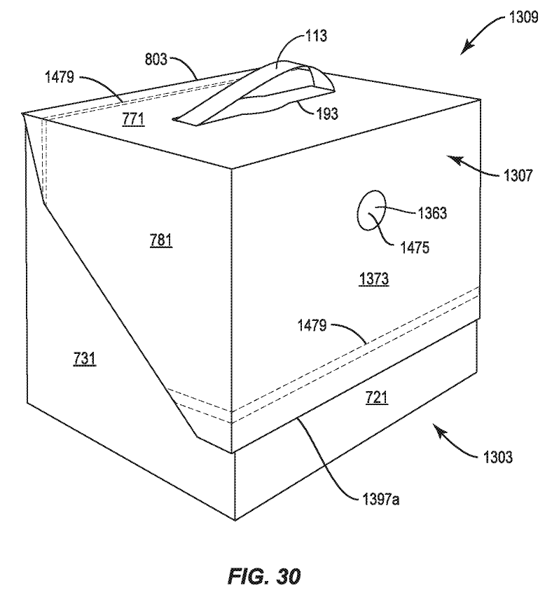

The carton 1309 could be otherwise formed without departing from the disclosure. In embodiments, the carton 1309 can be opened (unlocked and opened) and reclosed (closed and relocked) in a similar or identical manner as the cartons 709, 909 as described above. The carton 1309 is shown in the opened configuration in FIG. 28. Further, FIG. 29 shows the carton 1309 schematically as transparent/wireframe and with the lid 1307 pressed downwardly so that the disengaged locking features are visible through the lid front panel 1373. From the position shown in FIGS. 29 and 30, the bottom locking flap 1363 be accessed through the unlocking feature 1365/1475 in the lid front panel 1373 and pressed inwardly to disengage a respective locking tab 1461 from a respective locking slot 1467 and to position the bottom locking flap 1363 out of planar engagement with the lid locking panel 1395 to allow the lid part 1307 to be raised and the locking slots to clear the bottom locking tabs and position the carton 1309 in the open configuration (FIG. 28). The carton 1309 could be otherwise formed and/or could be otherwise opened and/or closed without departing from the disclosure.

In embodiments, the stronger blank material, the reinforcing strips 1479, the uncoated areas 1481, the glue assists 1483, the use of multiple locking tabs 1461 and multiple slots 1467, and/or the strategic use of glue strips/areas can help to reinforce the carton 1309 and its locking features so that the carton has increased resistance to opening (e.g., by attempting to open the lid and/or by attempting to bypass the locking features) by an unauthorized person (e.g., a child).

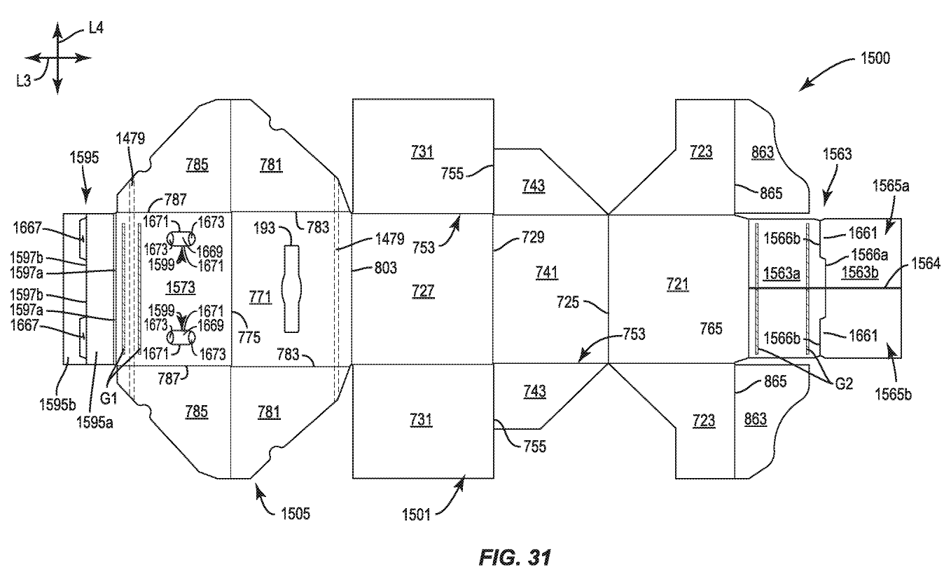

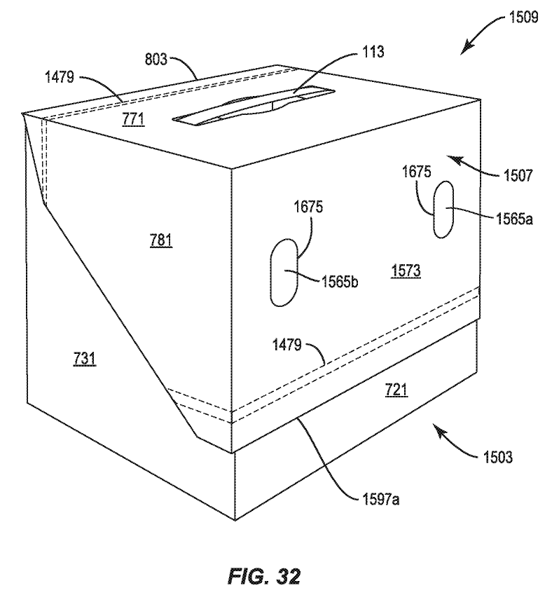

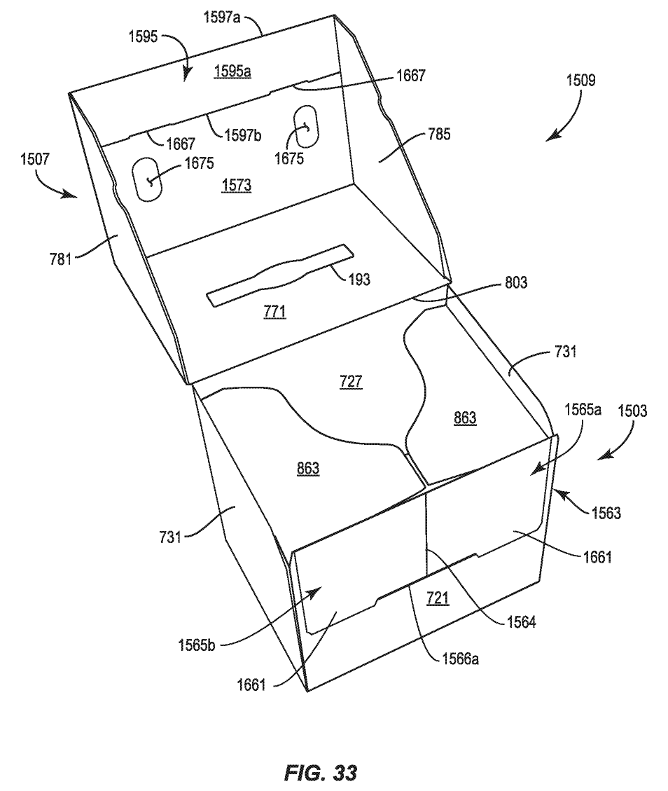

FIG. 31 is a plan view of a carton blank 1500 for forming a carton 1509 (FIGS. 32 and 33) of a sixth embodiment of the disclosure. The sixth embodiment is generally similar to the prior embodiments, except for variations noted and variations that will be apparent to one of ordinary skill in the art. Accordingly, similar or identical features of the embodiments have been given like or similar reference numbers. As shown in FIG. 31, the blank 1500 can be similar to the blank 700 of FIG. 13, the blank 900 of FIG. 18, and/or the blank 1300 of FIG. 26, and the panels and flaps that form the bottom portion 1501 and the top portion 1505 of the blank 1500 can have different sizes/proportions and/or different shapes than the same flaps and panels in the blanks 700, 900, 1300. As shown in FIG. 31, the blank 1500 can have a different lid locking panel 1595 and a different bottom locking flap 1563 than in prior embodiments, and the blank 1500 includes reinforcing features to further resist or prevent opening of the carton 1509.

As shown in FIG. 31, the bottom locking flap 1563 can include a proximal portion 1563a that is foldably connected to the base front panel 721 along the lateral fold line 765 and a distal portion 1563b that is foldably connected to the proximal portion 1563a along a lateral fold lines 1566a. In the illustrated embodiments, two locking tabs 1661 extend from the distal portion 1563b along the proximal portion 1563a and can be separable from the proximal portion 1563a along cut lines 1566b or other lines of weakening. In the illustrated embodiments, the distal portion 1595b of the lid locking panel 1595 can be foldably connected to the proximal portion 1595a along a lateral fold line 1597b, and one or more openings or slots 1667 (e.g., two slots) can extend in the distal portion 1595b along the proximal portion 1595a. In embodiments, the lateral fold line 1597b can extend between respectively adjacent slots 1667, and the slots 1667 can be at least partially aligned with the respective locking tabs 1661 defined in the bottom locking flap 1563 along the longitudinal direction L3. In the embodiment of FIGS. 31-33, the bottom locking flap 1563 includes a longitudinal line of weakening 1564 that extends from the lateral fold line 765 across the proximal portion 1563a and the distal portion 1563b of the bottom locking flap. The line of weakening 1564 could be a tear line or cut line or any other line of weakening that allows the bottom locking flap 1563 to be divided into a first portion 1565a that is moveable relative to a second portion 1565b in the carton 1509. Each of the first portion 1565a and the second portion 1565b of the bottom locking flap 1563 is foldably connected to the front panel 721 at the fold line 765 and includes a respective bottom locking tab 1661. In embodiments, the slots 1667 can be sized and shaped for at least partially receiving the respective locking tabs 1661 when the lid 1507 is formed and in a closed configuration (FIG. 32). The bottom locking flap 1563 and/or the lid locking panel 1595 could be omitted or could be otherwise shaped, arranged, configured, and/or positioned without departing from the disclosure.

In the illustrated embodiments, two unlocking feature/opening feature 1599 are in the lid front panel 1573. In exemplary embodiments, the opening feature 1599 can be round (e.g., a circle or oval shape). In embodiments, the opening feature 1599 can include a tear-out panel 1669 that can be separable from the lid front panel 1573 along a curved tear line 1671 and/or other suitable lines of weakening. In the illustrated embodiments, the opening feature 1699 can include apertures 1673 for grasping the tear-out panel 1669 and tearing it away from the lid front panel 1573 when initially opening the carton 1509. In exemplary embodiments, the at least partial removal of the tear-out panels 1669 can provide visual evidence that the carton 1509 has been opened and/or tampered with (e.g., tamper evident features). Once a respective tear-out panel 1669 is removed, an access opening 1675 is formed in the lid front panel 1573 (FIGS. 27-30) allowing access to a respective first portion 1565a and second portion 1565b of the bottom locking flap 1563. The unlocking feature/opening feature 1599 could be omitted or could be otherwise shaped, arranged, configured, and/or positioned without departing from the disclosure.

In the illustrated embodiments, the carton 1509 (FIG. 32-33) can be formed from the blank 1500 in a similar manner as the cartons 709, 909, 1309 are formed as described above. In embodiments, the lid locking panel 1595 can be folded along the lateral fold lines 1597b to position the portions 1595a, 1595b in overlapping relationship. In embodiments, the portions 1595a, 1595b can remain unglued to one another. Alternatively, the portions 1395a, 1395b can be glued together in face-to-face contact, such as with glue strips G1. As shown in FIGS. 33, the lid locking panel 1595 can be folded into overlapping relationship with the lid front panel 1573 (e.g., gluing the lid locking panel 1595 in face-to-face contact with the interior surface of the lid front panel 1573, such as with glue strips G1). When the lid locking panel 1595 is secured to the lid front panel 1573, the slots 1667 can form recesses or receiving spaces between the lid front panel 1573 and the proximal portion 1595a of the lid locking panel 1595.

In exemplary embodiments, the bottom locking flap 1563 can be formed by folding the distal portion 1563b of the bottom locking flap 1563 into face-to-face contact with the proximal portion 1563a. For example, the portions 1563a, 1563b can be glued and/or otherwise secured together, such as with glue strips G2 on the proximal portion 1563a and/or on the distal portion 1563b. In embodiments, the glue strips G2 can extend across the bottom locking flap 1563 in the lateral direction (e.g., from approximately one edge to approximately the opposing edge) to help secure the portions 1563a, 1563b together and to help resist separation of the portions 1563a, 1563b. Alternatively, the glue G2 could be otherwise applied. As shown in FIG. 33, the bottom locking flap 1563 can be folded along the fold line 765 over the exterior of the front panel 721, and the locking tabs 1661 can extend outwardly from the fold lines 1566a. In some embodiments, the bottom locking flap 1563 can be biased outwardly along the fold line 765, away from the base front panel 721. The first portion 1565a and the second portion 1565b of the bottom locking flap 1563 are separated by the line of weakness 1564 and are independently moveable with respect to the front panel 721.

In the illustrated embodiments, when the carton 1509 is in the erected and closed configuration (FIG. 32), the bottom locking flap 1563 and the lid locking panel 1595 can cooperate to resist opening of the carton 1509 (e.g., can resist pivoting the lid part 1507 relative to the base part 1503). For example, the first portion 1565a and second portion 1565b of the bottom locking flap 1563 can be biased outwardly or otherwise caused to move the locking tabs 1461 against the interior surface of the lid front panel 773, and the bias flaps 863 can be biased upwardly to engage (e.g., to be pressed against) the interior surface of the top panel 771. In embodiments, the bias flaps 863 can press upwardly on the lid part 1507 to bias the lid part 1507 upwardly toward engagement between the lid locking panel 1595 and the bottom locking flap 1563. Further, the bias flaps 863 are configured to increase the rigidity and stiffness of the carton 1509 by providing resistance to inward deformation of the side panels 723, 731, front pane 721, and/or back panel 727. When the lid locking panel 1595 and the bottom locking flap 1563 are engaged, the locking tabs 1661 of the bottom locking flap 1563 can be at least partially received in the respective slots 1667 in the lid locking panel 1595. In embodiments, the engagement between the lid locking panel 1595 and the bottom locking flap 1563 can resist pivoting of the lid part 1507 relative to the base part 1503, such as when attempting to open the lid part 1507 and/or lifting the carton 1509 at the handle. In addition, when the locking tabs 1661 are received in the respective slots 1667, the locking tabs can resist separation in the horizontal direction (e.g., if the lid front panel 1573 is pulled outwardly and/or the bottom locking flap 1563 is pushed inwardly, such as via an access opening 1675 in the lid front panel 1573, in an effort to bypass the locking features without pressing down on the lid 1507 first). In embodiments, the use of multiple locking tabs 1661 and multiple slots 1667 spread across the width of the carton 1509 and bottom locking flap 1563 and lid locking panel 1595 can help distribute the resistance to opening of the carton 1509, which can help to better lock the carton 1509 than if the locking features were only centered in the front of the carton, for example. A respective locking tab 1661 of the first portion 1565a and the second portion 1565b of the bottom locking flap 1563 is aligned with a respective locking opening/slot 1667 in the lid locking panel 1595 so that the respective locking tab engages the respective locking slot 1667 if the lid part 1507 is attempted to be raised without disengagement of the locking features.

The carton 1509 could be otherwise formed without departing from the disclosure. In embodiments, the carton 1509 can be opened (unlocked and opened) and reclosed (closed and relocked) in a similar or identical manner as the cartons 709, 909, 1309 as described above. The carton 1509 is shown in the opened configuration in FIG. 33 and the closed configuration in FIG. 32. From the position shown in FIG. 32, the first portion 1565a and the second portion 1565b of the bottom locking flap 1563 be accessed through a respective unlocking feature 1675 in the lid front panel 1573 and pressed inwardly to disengage a respective locking tab 1661 from a respective locking slot 1667 and to position each of the first portion 1565a and the second portion 1565b of the bottom locking flap 1563 out of planar engagement with the lid locking panel 1595 to allow the lid part 1507 to be raised and the locking slots to clear the bottom locking tabs and position the carton 1509 in the open configuration (FIG. 33). In the embodiment of FIGS. 31-33, each of the first portion 1565a and the second portion 1565b of the bottom locking flap 1563 are independent moveable and must be independent unlocked through a respective unlocking feature 1675 to allow the lid part 1507 to be raised. The carton 1509 could be otherwise formed and/or could be otherwise opened and/or closed without departing from the disclosure.

Any of the features of the various embodiments of the disclosure can be combined with, replaced by, or otherwise configured with other features of other embodiments of the disclosure without departing from the scope of this disclosure. For example, one or more of the features of the cartons formed by combining two blanks could be incorporated into a carton formed from a single blank.

Generally, as described herein, bags can be formed from a paper stock material, although various plastic or other bag materials also can be used and can be lined or coated with a desired material. The reinforcing sleeves described herein can be made from a more rigid material such as a clay-coated natural kraft (“CCNK”). Other materials such various card-stock, paper, plastic or other synthetic or natural materials also can be used to form the components of the packages described herein.

In general, the blanks of the present disclosure may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding there along. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for holding one or more products, the carton comprising:
a base part, the base part comprising a plurality of base panels extending at least partially around an interior of the carton and an at least partially open top end;
a lid part extending over at least a portion of the at least partially open top end of the base part in a closed configuration of the carton; and
locking features for cooperating to resist movement of the lid part relative to the base part from the closed configuration, the locking features being operable to be disengaged for allowing pivoting of lid part relative to the base part from the closed configuration to an open configuration of the carton,
the base part comprises a bottom locking flap, and the lid part comprises a lid locking panel foldably connected to a lid top panel, wherein the locking features comprise the bottom locking flap and the lid locking panel, and the bottom locking flap and the lid locking panel engage one another in a locking configuration to resist pivoting of the lid part relative to the base part in the closed configuration,
the bottom locking flap comprises a proximal portion foldably connected to a base panel of the plurality of base panels and a distal portion foldably connected to the proximal portion at a fold line, the proximal portion and the distal portion being in at least partial face-to-face contact, and at least one locking tab extends from the distal portion.

2. The carton of claim 1, wherein the at least one locking tab comprises at least two locking tabs, each locking tab of the at least two locking tabs is adjacent the fold line.

3. The carton of claim 2, wherein the lid part comprises a lid front panel, the lid locking panel comprises a proximal portion foldably connected to a lid front panel and a distal portion foldably connected to the proximal portion along a fold line, the proximal portion of the lid locking panel and the distal portion of the lid locking panel being in at least partial face-to-face contact.

4. The carton of claim 3, wherein the locking features comprise at least two slots extending along the proximal portion and the distal portion of the lid locking panel, and wherein a respective locking tab of the at least two locking tabs is at least partially received in a respective slot of the at least two slots when the bottom locking flap and the lid locking panel engage one another in the locking configuration.

5. The carton of claim 4, wherein the at least two locking tabs comprises three locking tabs and the at least three slots comprises three slots.

6. The carton of claim 4, wherein the bottom locking flap comprises a line of weakening separating the bottom locking flap into a first portion and a second portion, the first portion of the bottom locking flap being moveable relative to the second portion of the bottom locking flap.

7. The carton of claim 6, wherein the first portion comprises a first locking tab of the at least two locking tabs and the second portion comprises a second locking tab of the at least two locking tabs so that the first locking tab is independently moveable relative to the second locking tab.

8. The carton of claim 4, wherein the bottom locking flap is operable to be moved relative to the lid locking panel to disengage a respective locking tab from a respective slot for allowing pivoting of the lid part relative to the base part.

9. The carton of claim 8, wherein the lid front panel extends over the bottom locking flap when the bottom locking flap and the lid locking panel engage one another in the locking configuration,
an at least one unlocking feature extends in the lid front panel and at least partially overlaps the bottom locking flap, and wherein the at least one unlocking feature is operable to be pressed inwardly to engage the bottom locking flap and press the bottom locking flap inwardly, disengaging the bottom locking flap from the lid locking panel.

10. The carton of claim 9, wherein the at least one unlocking features comprises two access openings spaced apart in the lid front panel and positioned to access the bottom locking flap in the closed configuration.

11. The carton of claim 1, wherein the base part comprises one or more bias flaps foldably connected to one or more base panels of the plurality of base panels so that the one or more bias flaps press upwardly on the lid part to bias the lid locking panel toward engagement with the bottom locking flap.

12. The carton of claim 3, wherein the lid part comprises a top panel foldably connected to at least one of the plurality of base panels and the lid front panel, the lid comprise a lid front end flap foldably connected to the lid front panel and a top end flap foldably connected to the top panel, the lid front panel and the top end flap being in face-to-face contact and adhesively connected, the lid front end flap comprises glue assist cuts for increasing the adhesive connection between the lid front panel and the top end flap.

13. The carton of claim 12, wherein the front end flap includes an uncoated area for increasing the adhesive connection between the lid front panel and the top end flap.

14. The carton of claim 12 comprising a reinforcement strip adhesively attached to the top panel and the top end flap.

15. The carton of claim 14, wherein the reinforcement strip is a first reinforcement strip, the blank further comprises a second reinforcement strip adhesively attached to the lid front panel and the lid front end flap.

16. A blank for forming a carton for holding one or more products, the blank comprising:
a base portion, the base portion comprising a plurality of base panels, wherein the base portion is for at least partially forming a base part having an at least partially open top end when the carton is formed from the blank;
a lid portion for at least partially forming a lid part extending over at least a portion of the at least partially open top end of the base part when the carton is formed from the blank in a closed configuration of the carton formed from the blank; and
locking features for cooperating when the carton is formed from the blank to resist pivoting of the lid part relative to the base part from the closed configuration of the carton formed from the blank, the locking features being operable to be disengaged for allowing pivoting of the lid part relative to the base part when the carton is formed from the blank,
the base part comprises a bottom locking flap, and the lid portion comprises a lid locking panel foldably connected to a lid top panel, wherein the locking features comprise the bottom locking flap and the lid locking panel, and the bottom locking flap and the lid locking panel are for engaging one another in a locking configuration to resist pivoting of the lid part relative to the base part in the closed configuration of the carton formed from the blank,
the bottom locking flap comprises a proximal portion foldably connected to a base panel of the plurality of base panels and a distal portion foldably connected to the proximal portion at a fold line, the proximal portion and the distal portion for being in at least partial face-to-face contact, and at least one locking tab extends from the distal portion in the carton formed from the blank.

17. The blank of claim 16, wherein the at least one locking tab comprises at least two locking tabs, each locking tab of the at least two locking tabs is adjacent the fold line.

18. The blank of claim 17, wherein the lid part comprises a lid front panel, the lid locking panel comprises a proximal portion foldably connected to a lid front panel and a distal portion foldably connected to the proximal portion along a fold line, the proximal portion of the lid locking panel and the distal portion of the lid locking panel being in at least partial face-to-face contact in the carton formed from the blank.

19. The blank of claim 18, wherein the locking features comprise at least two slots extending along the proximal portion and the distal portion of the lid locking panel, and wherein a respective locking tab of the at least two locking tabs is at least partially received in a respective slot of the at least two slots when the bottom locking flap and the lid locking panel engage one another in the locking configuration of the carton formed from the blank.

20. The blank of claim 19, wherein the at least two locking tabs comprises three locking tabs and the at least three slots comprises three slots.

21. The blank of claim 19, wherein the bottom locking flap comprises a line of weakening separating the bottom locking flap into a first portion and a second portion, the first portion of the bottom locking flap being moveable relative to the second portion of the bottom locking flap.

22. The blank of claim 21, wherein the first portion comprises a first locking tab of the at least two locking tabs and the second portion comprises a second locking tab of the at least two locking tabs so that the first locking tab is independently moveable relative to the second locking tab.

23. The blank of claim 19, wherein the bottom locking flap is operable to be moved relative to the lid locking panel to disengage a respective locking tab from a respective slot for allowing pivoting of the lid part relative to the base part in the carton formed from the blank.

24. The blank of claim 23, wherein the lid front panel extends over the bottom locking flap when the bottom locking flap and the lid locking panel are for engaging one another in the locking configuration in the carton formed from the blank,
an at least one unlocking feature extends in the lid front panel and is for at least partially overlapping the bottom locking flap in the closed configuration of the carton formed from the blank, and wherein the at least one unlocking feature is operable to be pressed inwardly to engage the bottom locking flap and press the bottom locking flap inwardly, disengaging the bottom locking flap from the lid locking panel in the closed configuration of the carton formed from the blank.

25. The blank of claim 24, wherein the at least one unlocking features comprises two access openings spaced apart in the lid front panel and positioned to access the bottom locking flap in the closed configuration of the carton formed from the blank.

26. The blank of claim 18, wherein the lid portion comprises a top panel foldably connected to at least one of the plurality of base panels and the lid front panel, the lid portion comprise a lid front end flap foldably connected to the lid front panel and a top end flap foldably connected to the top panel.

27. The blank of claim 26, where the lid front panel and the top end flap are for being in face-to-face contact and adhesively connected in the carton formed from the blank, the lid front end flap comprises glue assist cuts for increasing the adhesive connection between the lid front panel and the top end flap in the carton formed from the blank.

28. The blank of claim 27, wherein the front end flap includes an uncoated area for increasing the adhesive connection between the lid front panel and the top end flap in the carton formed from the blank.

29. The blank of claim 27 comprising a reinforcement strip adhesively attached to the top panel and the top end flap.

30. The blank of claim 29, wherein the reinforcement strip is a first reinforcement strip, the blank further comprises a second reinforcement strip adhesively attached to the front panel and the front end flap.

31. A method of forming a carton, the method comprising:
obtaining a blank, the blank comprising a base portion, a lid portion, and locking features extending in the base portion and the lid portion, the base portion comprising a plurality of base panels;
forming a base part of the carton by positioning the plurality of base panels to extend at least partially around an interior of the base part, wherein the base part comprises an at least partially open top end;
forming a lid part of the carton from at least the lid portion of the blank; and
positioning the lid part to extend over at least a portion of the at least partially open top end of the base part in a closed configuration of the carton;
wherein the locking features are for cooperating to resist pivoting of the lid part relative to the base part from the closed configuration, and the locking features are operable to be disengaged for allowing pivoting of the lid part relative to the base part from the closed configuration to an open configuration of the carton,
the base portion comprises a bottom locking flap, and the lid portion comprises a lid locking panel foldably connected to a lid top panel, wherein the locking features comprise the bottom locking flap and the lid locking panel, and the bottom locking flap and the lid locking panel engage one another in a locking configuration to resist pivoting of the lid part relative to the base part in the closed configuration,
the bottom locking flap comprises a proximal portion foldably connected to a base panel of the plurality of base panels and a distal portion foldably connected to the proximal portion at a fold line, the forming the base part comprises positioning the proximal portion and the distal portion in an at least partial face-to-face contact and forming at least one locking tab extending from the distal portion.

32. The method of claim 31, wherein the forming at least one locking tab comprises forming at least two locking tabs, each locking tab of the at least two locking tabs is adjacent the fold line.

33. The method of claim 32, wherein the lid part comprises a lid front panel, the lid locking panel comprises a proximal portion foldably connected to a lid front panel and a distal portion foldably connected to the proximal portion along a fold line, the forming the lid part comprises positioning the proximal portion of the lid locking panel and the distal portion of the lid locking panel in at least partial face-to-face contact in the carton formed from the blank.

34. The method of claim 33, wherein the locking features comprise at least two slots extending along the proximal portion and the distal portion of the lid locking panel, and wherein a respective locking tab of the at least two locking tabs is at least partially received in a respective slot of the at least two slots when the bottom locking flap and the lid locking panel engage one another in the locking configuration of the carton.

35. The method of claim 34, wherein the at least two locking tabs comprises three locking tabs and the at least three slots comprises three slots.

36. The method of claim 34, wherein the bottom locking flap comprises a line of weakening separating the bottom locking flap into a first portion and a second portion, the first portion of the bottom locking flap is moveable relative to the second portion of the bottom locking flap.

37. The method of claim 36, wherein the first portion comprises a first locking tab of the at least two locking tabs and the second portion comprises a second locking tab of the at least two locking tabs so that the first locking tab is independently moveable relative to the second locking tab.

38. The method of claim 34, further comprising moving the bottom locking flap relative to the lid locking panel to disengage a respective locking tab from a respective slot and pivoting the lid part relative to the base part to position the carton in the open configuration.

39. The method of claim 38, wherein the lid front panel extends over the bottom locking flap when the bottom locking flap and the lid locking panel engage one another in the locking configuration of the carton,
an at least one unlocking feature extends in the lid front panel and is for at least partially overlapping the bottom locking flap in the closed configuration of the carton, and wherein the at least one unlocking feature is operable to be pressed inwardly to engage the bottom locking flap and press the bottom locking flap inwardly, disengaging the bottom locking flap from the lid locking panel in the closed configuration of the carton formed from the blank.

40. The method of claim 39, wherein the at least one unlocking features comprises two access openings spaced apart in the lid front panel and positioned to access the bottom locking flap in the closed configuration of the carton.

41. The method of claim 31, wherein the base part comprises one or more bias flaps foldably connected to one or more base panels of the plurality of base panels, the one or more bias flaps are for pressing upwardly on the lid part to bias the lid locking panel toward engagement with the bottom locking flap in the closed configuration of the carton.

42. The method of claim 33, wherein the lid portion comprises a top panel foldably connected to at least one of the plurality of base panels and the lid front panel, the lid portion comprise a lid front end flap foldably connected to the lid front panel and a top end flap foldably connected to the top panel, the forming the lid part comprises positioning the lid front panel and the top end flap in face-to-face contact and adhesively connected, the lid front end flap comprises glue assist cuts for increasing the adhesive connection between the lid front panel and the top end flap.

43. The method of claim 42, wherein the front end flap includes an uncoated area for increasing the adhesive connection between the lid front panel and the top end flap.
